(19) United States
(12) Patent Application Publication
(10) Pub. No.: US 2025/0310908 A1
(43) Pub. Date: Oct. 2, 2025

(54) DEADLOCK PREVENTION TECHNIQUES FOR RSU SYNCHRONIZATION CHAINS

(71) Applicant: QUALCOMM Incorporated, San Diego, CA (US)

(72) Inventors: Jianqiang ZHANG, Beijing (CN); Cheol Hee PARK, San Diego, CA (US); Yi QIN, Beijing (CN); Rejus BABU REDDY, San Diego, CA (US); Jintao HOU, Beijing (CN); Xin XIONG, Shanghai (CN); Mingming HU, Shanghai (CN)

(21) Appl. No.: 18/873,140

(22) PCT Filed: Aug. 31, 2022
(86) PCT No.: PCT/CN2022/116058

§ 371 Date: Dec. 9, 2024

(51) Int. Cl. H04W 56/00; H04W 92/18

(52) U.S. Cl. CPC H04W 56/0015; H04W 92/18

(57) ABSTRACT

Deadlock prevention techniques for roadside unit (RSU) synchronization chains are disclosed. The techniques can include detecting, on a wireless carrier, while a first synchronization reference is a synchronization reference source for the wireless communication device, a first reference signal associated with the first synchronization reference, transmitting sidelink synchronization signals (SLSSs) on the wireless carrier according to a timing indicated by the first reference signal, and responsive to a subsequent determination that the first synchronization reference has become unavailable, adopting a second synchronization reference as the synchronization reference source for the wireless communication device, initiating a wait interval, and following expiration of the wait interval, monitoring the wireless carrier for a second reference signal associated with the second synchronization reference and refraining from transmitting SLSSs on the wireless carrier while the second reference signal is not detected on the wireless carrier.

### BACKGROUND

### 1. Field of Disclosure

The present disclosure relates generally to the field of wireless communications, and more specifically to synchronizing the timings of devices in wireless communication systems.

### 2. Description of Related Art

A vehicle-to-everything (V2X) communication system can be deployed along a roadway in order to provide wireless data connectivity to vehicles traveling the roadway. The V2X communication system can comprise V2X roadside units (RSUs) that can communicate with V2X on-board units (OBUs) of passing vehicles. Successful communication between the V2X RSUs and V2X OBUs can depend on the establishment of timing synchronization among those various devices.

### BRIEF SUMMARY

An example method for wireless communication by a wireless communication device, according to this disclosure, may comprise detecting, on a wireless carrier, while a first synchronization reference is a synchronization reference source for the wireless communication device, a first reference signal associated with the first synchronization reference, transmitting sidelink synchronization signals (SLSSs) on the wireless carrier according to a timing indicated by the first reference signal, and responsive to a subsequent determination that the first synchronization reference has become unavailable, adopting a second synchronization reference as the synchronization reference source for the wireless communication device, initiating a wait interval, and following expiration of the wait interval, monitoring the wireless carrier for a second reference signal associated with the second synchronization reference and refraining from transmitting SLSSs on the wireless carrier while the second reference signal is not detected on the wireless carrier.

An example wireless communication device, according to this disclosure, may comprise a transceiver, a memory, and one or more processors communicatively coupled with the transceiver and the memory, wherein the one or more processors are configured to detect, on a wireless carrier, while a first synchronization reference is a synchronization reference source for the wireless communication device, a first reference signal associated with the first synchronization reference, transmit sidelink synchronization signals (SLSSs) on the wireless carrier according to a timing indicated by the first reference signal, and responsive to a subsequent determination that the first synchronization reference has become unavailable, adopt a second synchronization reference as the synchronization reference source for the wireless communication device, initiate a wait interval, and following expiration of the wait interval, monitor the wireless carrier for a second reference signal associated with the second synchronization reference and refrain from transmitting SLSSs on the wireless carrier while the second reference signal is not detected on the wireless carrier.

An example apparatus for a wireless communication device, according to this disclosure, may comprise means for detecting, on a wireless carrier, while a first synchronization reference is a synchronization reference source for the wireless communication device, a first reference signal associated with the first synchronization reference, means for transmitting sidelink synchronization signals (SLSSs) on the wireless carrier according to a timing indicated by the first reference signal, and means for, responsive to a subsequent determination that the first synchronization reference has become unavailable, adopting a second synchronization reference as the synchronization reference source for the wireless communication device, initiating a wait interval, and following expiration of the wait interval, monitoring the wireless carrier for a second reference signal associated with the second synchronization reference and refraining from transmitting SLSSs on the wireless carrier while the second reference signal is not detected on the wireless carrier.

An example non-transitory computer-readable medium, according to this disclosure, may store instructions for wireless communication by a wireless communication device, the instructions comprising code for detecting, on a wireless carrier, while a first synchronization reference is a synchronization reference source for the wireless communication device, a first reference signal associated with the first synchronization reference, transmitting sidelink synchronization signals (SLSSs) on the wireless carrier according to a timing indicated by the first reference signal, and responsive to a subsequent determination that the first synchronization reference has become unavailable, adopting a second synchronization reference as the synchronization reference source for the wireless communication device, initiating a wait interval, and following expiration of the wait interval, monitoring the wireless carrier for a second reference signal associated with the second synchronization reference and refraining from transmitting SLSSs on the wireless carrier while the second reference signal is not detected on the wireless carrier.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is a diagram of a positioning system, according to an embodiment.

FIG. 2 is a diagram of a 5th Generation (5G) New Radio (NR) positioning system, illustrating an embodiment of a positioning system (e.g., the positioning system of FIG. 1) implemented within a 5G NR communication network.

FIG. 3 is a diagram showing an example of a frame structure for NR and associated terminology.

FIG. 4 is a diagram showing an example of a wireless communication system.

FIG. 5 is a diagram showing an example of an operating environment.

FIG. 6 is a diagram showing an example of a first event flow.

FIG. 7 is a diagram showing an example of a second event flow.

FIG. 8 is a flow diagram of a method for wireless communication by a wireless communication device, according to an embodiment.

FIG. 9 is a block diagram of an embodiment of a UE, which can be utilized in embodiments as described herein.

FIG. 10 is a block diagram of an embodiment of a base station, which can be utilized in embodiments as described herein.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

The following description is directed to certain implementations for the purposes of describing innovative aspects of various embodiments. However, a person having ordinary skill in the art will readily recognize that the teachings herein can be applied in a multitude of different ways. The described implementations may be implemented in any device, system, or network that is capable of transmitting and receiving radio frequency (RF) signals according to any communication standard, such as any of the Institute of Electrical and Electronics Engineers (IEEE) 802.15.4 standards for ultra-wideband (UWB), IEEE 802.11 standards (including those identified as Wi-Fi® technologies), the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Rate Packet Data (HRPD), High Speed Packet Access (HSPA), High Speed Downlink Packet Access (HSDPA), High Speed Uplink Packet Access (HSUPA), Evolved High Speed Packet Access (HSPA+), Long Term Evolution (LTE), Advanced Mobile Phone System (AMPS), or other known signals that are used to communicate within a wireless, cellular or internet of things (IoT) network, such as a system utilizing 3G, 4G, 5G, 6G, or further implementations thereof, technology.

As used herein, an “RF signal” comprises an electromagnetic wave that transports information through the space between a transmitter (or transmitting device) and a receiver (or receiving device). As used herein, a transmitter may transmit a single “RF signal” or multiple “RF signals” to a receiver. However, the receiver may receive multiple “RF signals” corresponding to each transmitted RF signal due to the propagation characteristics of RF signals through multiple channels or paths.

Additionally, unless otherwise specified, references to “reference signals,” “positioning reference signals,” “reference signals for positioning,” and the like may be used to refer to signals used for positioning of a user equipment (UE). As described in more detail herein, such signals may comprise any of a variety of signal types but may not necessarily be limited to a Positioning Reference Signal (PRS) as defined in relevant wireless standards.

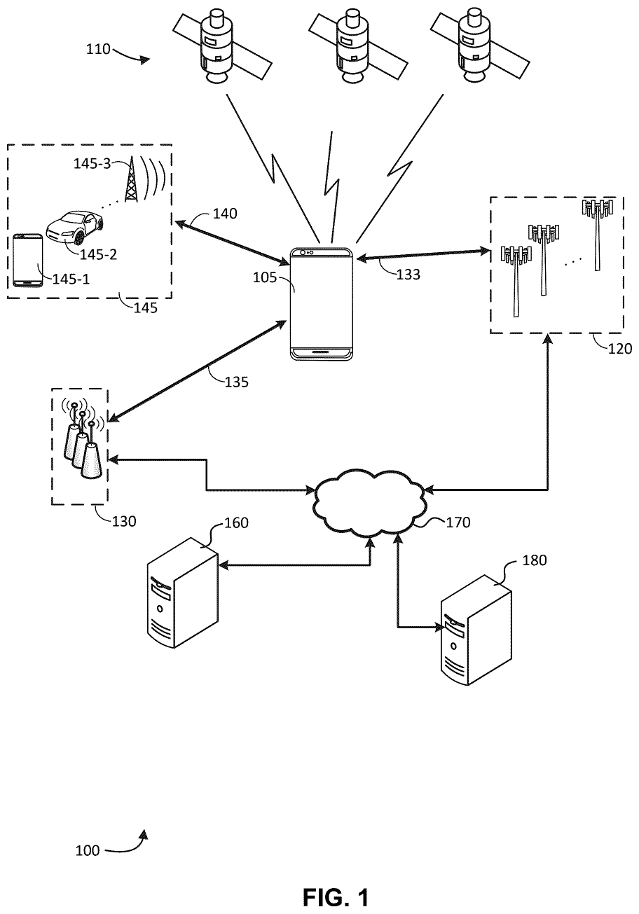

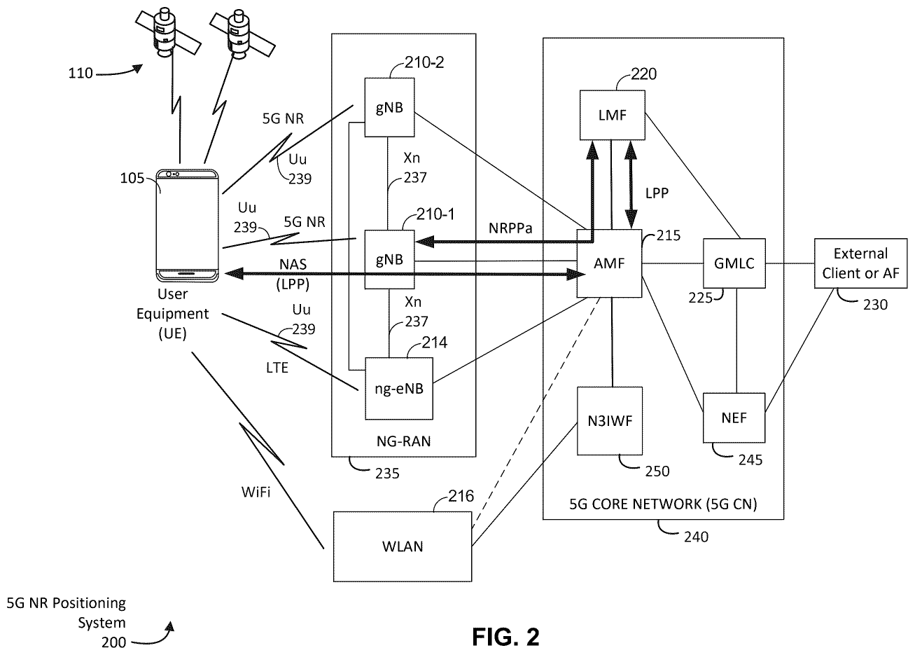

FIG. 1 is a simplified illustration of a positioning system 100 in which a UE 105, location server 160, and/or other components of the positioning system 100 can use the techniques provided herein for deadlock prevention for RSU synchronization chains, according to an embodiment. The techniques described herein may be implemented by one or more components of the positioning system 100. The positioning system 100 can include: a UE 105; one or more satellites 110 (also referred to as space vehicles (SVs)), which may include Global Navigation Satellite System (GNSS) satellites (e.g., satellites of the Global Positioning System (GPS), GLONASS, Galileo, Beidou, etc.) and/or Non-Terrestrial Network (NTN) satellites; base stations 120; access points (APs) 130; location server 160; network 170; and external client 180. Generally put, the positioning system 100 can estimate a location of the UE 105 based on RF signals received by and/or sent from the UE 105 and known locations of other components (e.g., GNSS satellites 110, base stations 120, APs 130) transmitting and/or receiving the RF signals. Additional details regarding particular location estimation techniques are discussed in more detail with regard to FIG. 2.

It should be noted that FIG. 1 provides only a generalized illustration of various components, any or all of which may be utilized as appropriate, and each of which may be duplicated as necessary. Specifically, although only one UE 105 is illustrated, it will be understood that many UEs (e.g., hundreds, thousands, millions, etc.) may utilize the positioning system 100. Similarly, the positioning system 100 may include a larger or smaller number of base stations 120 and/or APs 130 than illustrated in FIG. 1. The illustrated connections that connect the various components in the positioning system 100 comprise data and signaling connections which may include additional (intermediary) components, direct or indirect physical and/or wireless connections, and/or additional networks. Furthermore, components may be rearranged, combined, separated, substituted, and/or omitted, depending on desired functionality. In some embodiments, for example, the external client 180 may be directly connected to location server 160. A person of ordinary skill in the art will recognize many modifications to the components illustrated.

Depending on desired functionality, the network 170 may comprise any of a variety of wireless and/or wireline networks. The network 170 can, for example, comprise any combination of public and/or private networks, local and/or wide-area networks, and the like. Furthermore, the network 170 may utilize one or more wired and/or wireless communication technologies. In some embodiments, the network 170 may comprise a cellular or other mobile network, a wireless local area network (WLAN), a wireless wide-area network (WWAN), and/or the Internet, for example. Examples of network 170 include a Long-Term Evolution (LTE) wireless network, a Fifth Generation (5G) wireless network (also referred to as New Radio (NR) wireless network or 5G NR wireless network), a Wi-Fi WLAN, and the Internet. LTE, 5G and NR are wireless technologies defined, or being defined, by the 3rd Generation Partnership Project (3GPP). Network 170 may also include more than one network and/or more than one type of network.

The base stations 120 and access points (APs) 130 may be communicatively coupled to the network 170. In some embodiments, the base station 120s may be owned, maintained, and/or operated by a cellular network provider, and may employ any of a variety of wireless technologies, as described herein below. Depending on the technology of the network 170, a base station 120 may comprise a node B, an Evolved Node B (eNodeB or eNB), a base transceiver station (BTS), a radio base station (RBS), an NR NodeB (gNB), a Next Generation eNB (ng-eNB), or the like. A base station 120 that is a gNB or ng-eNB may be part of a Next Generation Radio Access Network (NG-RAN) which may connect to a 5G Core Network (5GC) in the case that Network 170 is a 5G network. The functionality performed by a base station 120 in earlier-generation networks (e.g., 3G and 4G) may be separated into different functional components (e.g., radio units (RUS), distributed units (DUs), and central units (CUs)) and layers (e.g., L1/L2/L3) in view Open Radio Access Networks (O-RAN) and/or Virtualized Radio Access Network (V-RAN or vRAN) in 5G or later networks, which may be executed on different devices at different locations connected, for example, via fronthaul, midhaul, and backhaul connections. As referred to herein, a “base station” (or ng-eNB, gNB, etc.) may include any or all of these functional components. An AP 130 may comprise a Wi-Fi AP or a Bluetooth® AP or an AP having cellular capabilities (e.g., 4G LTE and/or 5G NR), for example. Thus, UE 105 can send and receive information with network-connected devices, such as location server 160, by accessing the network 170 via a base station 120 using a first communication link 133. Additionally or alternatively, because APs 130 also may be communicatively coupled with the network 170, UE 105 may communicate with network-connected and Internet-connected devices, including location server 160, using a second communication link 135, or via one or more other mobile devices 145.

As used herein, the term “base station” may generically refer to a single physical transmission point, or multiple co-located physical transmission points, which may be located at a base station 120. A Transmission Reception Point (TRP) (also known as transmit/receive point) corresponds to this type of transmission point, and the term “TRP” may be used interchangeably herein with the terms “gNB,” “ng-eNB,” and “base station.” In some cases, a base station 120 may comprise multiple TRPs—e.g. with each TRP associated with a different antenna or a different antenna array for the base station 120. As used herein, the transmission functionality of a TRP may be performed with a transmission point (TP) and/or the reception functionality of a TRP may be performed by a reception point (RP), which may be physically separate or distinct from a TP. That said, a TRP may comprise both a TP and an RP. Physical transmission points may comprise an array of antennas of a base station 120 (e.g., as in a Multiple Input-Multiple Output (MIMO) system and/or where the base station employs beamforming). The term “base station” may additionally refer to multiple non-co-located physical transmission points, the physical transmission points may be a Distributed Antenna System (DAS) (a network of spatially separated antennas connected to a common source via a transport medium) or a Remote Radio Head (RRH) (a remote base station connected to a serving base station).

As used herein, the term “cell” may generically refer to a logical communication entity used for communication with a base station 120, and may be associated with an identifier for distinguishing neighboring cells (e.g., a Physical Cell Identifier (PCID), a Virtual Cell Identifier (VCID)) operating via the same or a different carrier. In some examples, a carrier may support multiple cells, and different cells may be configured according to different protocol types (e.g., Machine-Type Communication (MTC), Narrowband Internet-of-Things (NB-IoT), Enhanced Mobile Broadband (eMBB), or others) that may provide access for different types of devices. In some cases, the term “cell” may refer to a portion of a geographic coverage area (e.g., a sector) over which the logical entity operates.

Satellites 110 may be utilized for positioning of the UE 105 in one or more ways. For example, satellites 110 (also referred to as space vehicles (SVs)) may be part of a Global Navigation Satellite System (GNSS) such as the Global Positioning System (GPS), GLONASS, Galileo or Beidou. Positioning using RF signals from GNSS satellites may comprise measuring multiple GNSS signals at a GNSS receiver of the UE 105 to perform code-based and/or carrier-based positioning, which can be highly accurate. Additionally or alternatively, satellites 110 may be utilized for NTN-based positioning, in which satellites 110 may functionally operate as TRPs (or TPs) of a network (e.g., LTE and/or NR network) and may be communicatively coupled with network 170. In particular, reference signals (e.g., PRS) transmitted by satellites 110 NTN-based positioning may be similar to those transmitted by base stations 120, and may be coordinated by a location server 160. In some embodiments, satellites 110 used for NTN-based positioning may be different than those used for GNSS-based positioning. In some embodiments NTN nodes may include non-terrestrial vehicles such as airplanes, balloons, drones, etc., which may be in addition or as an alternative to NTN satellites.

The location server 160 may comprise a server and/or other computing device configured to determine an estimated location of UE 105 and/or provide data (e.g., “assistance data”) to UE 105 to facilitate location measurement and/or location determination by UE 105. According to some embodiments, location server 160 may comprise a Home Secure User Plane Location (SUPL) Location Platform (H-SLP), which may support the SUPL user plane (UP) location solution defined by the Open Mobile Alliance (OMA) and may support location services for UE 105 based on subscription information for UE 105 stored in location server 160. In some embodiments, the location server 160 may comprise, a Discovered SLP (D-SLP) or an Emergency SLP (E-SLP). The location server 160 may also comprise an Enhanced Serving Mobile Location Center (E-SMLC) that supports location of UE 105 using a control plane (CP) location solution for LTE radio access by UE 105. The location server 160 may further comprise a Location Management Function (LMF) that supports location of UE 105 using a control plane (CP) location solution for NR or LTE radio access by UE 105.

In a CP location solution, signaling to control and manage the location of UE 105 may be exchanged between elements of network 170 and with UE 105 using existing network interfaces and protocols and as signaling from the perspective of network 170. In a UP location solution, signaling to control and manage the location of UE 105 may be exchanged between location server 160 and UE 105 as data (e.g. data transported using the Internet Protocol (IP) and/or Transmission Control Protocol (TCP)) from the perspective of network 170.

As previously noted (and discussed in more detail below), the estimated location of UE 105 may be based on measurements of RF signals sent from and/or received by the UE 105. In particular, these measurements can provide information regarding the relative distance and/or angle of the UE 105 from one or more components in the positioning system 100 (e.g., GNSS satellites 110, APs 130, base stations 120). The estimated location of the UE 105 can be estimated geometrically (e.g., using multiangulation and/or multilateration), based on the distance and/or angle measurements, along with known position of the one or more components.

Although terrestrial components such as APs 130 and base stations 120 may be fixed, embodiments are not so limited. Mobile components may be used. For example, in some embodiments, a location of the UE 105 may be estimated at least in part based on measurements of RF signals 140 communicated between the UE 105 and one or more other mobile devices 145, which may be mobile or fixed. As illustrated, other mobile devices may include, for example, a mobile phone 145-1, vehicle 145-2, static communication/positioning device 145-3, or other static and/or mobile device capable of providing wireless signals used for positioning the UE 105, or a combination thereof. Wireless signals from mobile devices 145 used for positioning of the UE 105 may comprise RF signals using, for example, Bluetooth® (including Bluetooth Low Energy (BLE)), IEEE 802.11x (e.g., Wi-Fi®), Ultra Wideband (UWB), IEEE 802.15x, or a combination thereof. Mobile devices 145 may additionally or alternatively use non-RF wireless signals for positioning of the UE 105, such as infrared signals or other optical technologies.

Mobile devices 145 may comprise other UEs communicatively coupled with a cellular or other mobile network (e.g., network 170). When one or more other mobile devices 145 comprising UEs are used in the position determination of a particular UE 105, the UE 105 for which the position is to be determined may be referred to as the “target UE,” and each of the other mobile devices 145 used may be referred to as an “anchor UE.” For position determination of a target UE, the respective positions of the one or more anchor UEs may be known and/or jointly determined with the target UE. Direct communication between the one or more other mobile devices 145 and UE 105 may comprise sidelink and/or similar Device-to-Device (D2D) communication technologies. Sidelink, which is defined by 3GPP, is a form of D2D communication under the cellular-based LTE and NR standards. UWB may be one such technology by which the positioning of a target device (e.g., UE 105) may be facilitated using measurements from one or more anchor devices (e.g., mobile devices 145).

According to some embodiments, such as when the UE 105 comprises and/or is incorporated into a vehicle, a form of D2D communication used by the mobile device 105 may comprise vehicle-to-everything (V2X) communication. V2X is a communication standard for vehicles and related entities to exchange information regarding a traffic environment. V2X can include vehicle-to-vehicle (V2V) communication between V2X-capable vehicles, vehicle-to-infrastructure (V2I) communication between the vehicle and infrastructure-based devices (commonly termed roadside units (RSUs)), vehicle-to-person (V2P) communication between vehicles and nearby people (pedestrians, cyclists, and other road users), and the like. Further, V2X can use any of a variety of wireless RF communication technologies. Cellular V2X (CV2X), for example, is a form of V2X that uses cellular-based communication such as LTE (4G), NR (5G) and/or other cellular technologies in a direct-communication mode as defined by 3GPP. The UE 105 illustrated in FIG. 1 may correspond to a component or device on a vehicle, RSU, or other V2X entity that is used to communicate V2X messages. In embodiments in which V2X is used, the static communication/positioning device 145-3 (which may correspond with an RSU) and/or the vehicle 145-2, therefore, may communicate with the UE 105 and may be used to determine the position of the UE 105 using techniques similar to those used by base stations 120 and/or APs 130 (e.g., using multiangulation and/or multilateration). It can be further noted that mobile devices 145 (which may include V2X devices), base stations 120, and/or APs 130 may be used together (e.g., in a WWAN positioning solution) to determine the position of the UE 105, according to some embodiments.

An estimated location of UE 105 can be used in a variety of applications—e.g. to assist direction finding or navigation for a user of UE 105 or to assist another user (e.g. associated with external client 180) to locate UE 105. A “location” is also referred to herein as a “location estimate”, “estimated location”, “location”, “position”, “position estimate”, “position fix”, “estimated position”, “location fix” or “fix”. The process of determining a location may be referred to as “positioning,” “position determination,” “location determination,” or the like. A location of UE 105 may comprise an absolute location of UE 105 (e.g. a latitude and longitude and possibly altitude) or a relative location of UE 105 (e.g. a location expressed as distances north or south, east or west and possibly above or below some other known fixed location (including, e.g., the location of a base station 120 or AP 130) or some other location such as a location for UE 105 at some known previous time, or a location of a mobile device 145 (e.g., another UE) at some known previous time). A location may be specified as a geodetic location comprising coordinates which may be absolute (e.g. latitude, longitude and optionally altitude), relative (e.g. relative to some known absolute location) or local (e.g. X, Y and optionally Z coordinates according to a coordinate system defined relative to a local area such a factory, warehouse, college campus, shopping mall, sports stadium or convention center). A location may instead be a civic location and may then comprise one or more of a street address (e.g. including names or labels for a country, state, county, city, road and/or street, and/or a road or street number), and/or a label or name for a place, building, portion of a building, floor of a building, and/or room inside a building etc. A location may further include an uncertainty or error indication, such as a horizontal and possibly vertical distance by which the location is expected to be in error or an indication of an area or volume (e.g. a circle or ellipse) within which UE 105 is expected to be located with some level of confidence (e.g. 95% confidence).

The external client 180 may be a web server or remote application that may have some association with UE 105 (e.g. may be accessed by a user of UE 105) or may be a server, application, or computer system providing a location service to some other user or users which may include obtaining and providing the location of UE 105 (e.g. to enable a service such as friend or relative finder, or child or pet location). Additionally or alternatively, the external client 180 may obtain and provide the location of UE 105 to an emergency services provider, government agency, etc.

As previously noted, the example positioning system 100 can be implemented using a wireless communication network, such as an LTE-based or 5G NR-based network. FIG. 2 shows a diagram of a 5G NR positioning system 200, illustrating an embodiment of a positioning system (e.g., positioning system 100) implementing 5G NR. The 5G NR positioning system 200 may be configured to determine the location of a UE 105 by using access nodes, which may include NR NodeB (gNB) 210-1 and 210-2 (collectively and generically referred to herein as gNBs 210), ng-eNB 214, and/or WLAN 216 to implement one or more positioning methods. The gNBs 210 and/or the ng-eNB 214 may correspond with base stations 120 of FIG. 1, and the WLAN 216 may correspond with one or more access points 130 of FIG. 1. Optionally, the 5G NR positioning system 200 additionally may be configured to determine the location of a UE 105 by using an LMF 220 (which may correspond with location server 160) to implement the one or more positioning methods. Here, the 5G NR positioning system 200 comprises a UE 105, and components of a 5G NR network comprising a Next Generation (NG) Radio Access Network (RAN) (NG-RAN) 235 and a 5G Core Network (5G CN) 240. A 5G network may also be referred to as an NR network; NG-RAN 235 may be referred to as a 5G RAN or as an NR RAN; and 5G CN 240 may be referred to as an NG Core network.

The 5G NR positioning system 200 may further utilize information from satellites 110. As previously indicated, satellites 110 may comprise GNSS satellites from a GNSS system like Global Positioning System (GPS) or similar system (e.g. GLONASS, Galileo, Beidou, Indian Regional Navigational Satellite System (IRNSS)). Additionally or alternatively, satellites 110 may comprise NTN satellites that may be communicatively coupled with the LMF 220 and may operatively function as a TRP (or TP) in the NG-RAN 235. As such, satellites 110 may be in communication with one or more gNB 210.

It should be noted that FIG. 2 provides only a generalized illustration of various components, any or all of which may be utilized as appropriate, and each of which may be duplicated or omitted as necessary. Specifically, although only one UE 105 is illustrated, it will be understood that many UEs (e.g., hundreds, thousands, millions, etc.) may utilize the 5G NR positioning system 200. Similarly, the 5G NR positioning system 200 may include a larger (or smaller) number of satellites 110, gNBs 210, ng-eNBs 214, Wireless Local Area Networks (WLANs) 216, Access and mobility Management Functions (AMF)s 215, external clients 230, and/or other components. The illustrated connections that connect the various components in the 5G NR positioning system 200 include data and signaling connections which may include additional (intermediary) components, direct or indirect physical and/or wireless connections, and/or additional networks. Furthermore, components may be rearranged, combined, separated, substituted, and/or omitted, depending on desired functionality.

The UE 105 may comprise and/or be referred to as a device, a mobile device, a wireless device, a mobile terminal, a terminal, a mobile station (MS), a Secure User Plane Location (SUPL)-Enabled Terminal (SET), or by some other name. Moreover, UE 105 may correspond to a cellphone, smartphone, laptop, tablet, personal data assistant (PDA), navigation device, Internet of Things (IoT) device, or some other portable or moveable device. Typically, though not necessarily, the UE 105 may support wireless communication using one or more Radio Access Technologies (RATs) such as using GSM, CDMA, W-CDMA, LTE, High Rate Packet Data (HRPD), IEEE 802.11 Wi-Fi®, Bluetooth, Worldwide Interoperability for Microwave Access (WiMAX™), 5G NR (e.g., using the NG-RAN 235 and 5G CN 240), etc. The UE 105 may also support wireless communication using a WLAN 216 which (like the one or more RATs, and as previously noted with respect to FIG. 1) may connect to other networks, such as the Internet. The use of one or more of these RATs may allow the UE 105 to communicate with an external client 230 (e.g., via elements of 5G CN 240 not shown in FIG. 2, or possibly via a Gateway Mobile Location Center (GMLC) 225) and/or allow the external client 230 to receive location information regarding the UE 105 (e.g., via the GMLC 225). The external client 230 of FIG. 2 may correspond to external client 180 of FIG. 1, as implemented in or communicatively coupled with a 5G NR network.

The UE 105 may include a single entity or may include multiple entities, such as in a personal area network where a user may employ audio, video and/or data I/O devices, and/or body sensors and a separate wireline or wireless modem. An estimate of a location of the UE 105 may be referred to as a location, location estimate, location fix, fix, position, position estimate, or position fix, and may be geodetic, thus providing location coordinates for the UE 105 (e.g., latitude and longitude), which may or may not include an altitude component (e.g., height above sea level, height above or depth below ground level, floor level or basement level). Alternatively, a location of the UE 105 may be expressed as a civic location (e.g., as a postal address or the designation of some point or small area in a building such as a particular room or floor). A location of the UE 105 may also be expressed as an area or volume (defined either geodetically or in civic form) within which the UE 105 is expected to be located with some probability or confidence level (e.g., 67%, 95%, etc.). A location of the UE 105 may further be a relative location comprising, for example, a distance and direction or relative X, Y (and Z) coordinates defined relative to some origin at a known location which may be defined geodetically, in civic terms, or by reference to a point, area, or volume indicated on a map, floor plan or building plan. In the description contained herein, the use of the term location may comprise any of these variants unless indicated otherwise. When computing the location of a UE, it is common to solve for local X, Y, and possibly Z coordinates and then, if needed, convert the local coordinates into absolute ones (e.g. for latitude, longitude and altitude above or below mean sea level).

Base stations in the NG-RAN 235 shown in FIG. 2 may correspond to base stations 120 in FIG. 1 and may include gNBs 210. Pairs of gNBs 210 in NG-RAN 235 may be connected to one another (e.g., directly as shown in FIG. 2 or indirectly via other gNBs 210). The communication interface between base stations (gNBs 210 and/or ng-eNB 214) may be referred to as an Xn interface 237. Access to the 5G network is provided to UE 105 via wireless communication between the UE 105 and one or more of the gNBs 210, which may provide wireless communications access to the 5G CN 240 on behalf of the UE 105 using 5G NR. The wireless interface between base stations (gNBs 210 and/or ng-eNB 214) and the UE 105 may be referred to as a Uu interface 239. 5G NR radio access may also be referred to as NR radio access or as 5G radio access. In FIG. 2, the serving gNB for UE 105 is assumed to be gNB 210-1, although other gNBs (e.g. gNB 210-2) may act as a serving gNB if UE 105 moves to another location or may act as a secondary gNB to provide additional throughput and bandwidth to UE 105.

Base stations in the NG-RAN 235 shown in FIG. 2 may also or instead include a next generation evolved Node B, also referred to as an ng-eNB, 214. Ng-eNB 214 may be connected to one or more gNBs 210 in NG-RAN 235—e.g. directly or indirectly via other gNBs 210 and/or other ng-eNBs. An ng-eNB 214 may provide LTE wireless access and/or evolved LTE (eLTE) wireless access to UE 105. Some gNBs 210 (e.g. gNB 210-2) and/or ng-eNB 214 in FIG. 2 may be configured to function as positioning-only beacons which may transmit signals (e.g., Positioning Reference Signal (PRS)) and/or may broadcast assistance data to assist positioning of UE 105 but may not receive signals from UE 105 or from other UEs. Some gNBs 210 (e.g., gNB 210-2 and/or another gNB not shown) and/or ng-eNB 214 may be configured to function as detecting-only nodes may scan for signals containing, e.g., PRS data, assistance data, or other location data. Such detecting-only nodes may not transmit signals or data to UEs but may transmit signals or data (relating to, e.g., PRS, assistance data, or other location data) to other network entities (e.g., one or more components of 5G CN 240, external client 230, or a controller) which may receive and store or use the data for positioning of at least UE 105. It is noted that while only one ng-eNB 214 is shown in FIG. 2, some embodiments may include multiple ng-eNBs 214. Base stations (e.g., gNBs 210 and/or ng-eNB 214) may communicate directly with one another via an Xn communication interface. Additionally or alternatively, base stations may communicate directly or indirectly with other components of the 5G NR positioning system 200, such as the LMF 220 and AMF 215.

5G NR positioning system 200 may also include one or more WLANs 216 which may connect to a Non-3GPP InterWorking Function (N3IWF) 250 in the 5G CN 240 (e.g., in the case of an untrusted WLAN 216). For example, the WLAN 216 may support IEEE 802.11 Wi-Fi access for UE 105 and may comprise one or more Wi-Fi APs (e.g., APs 130 of FIG. 1). Here, the N3IWF 250 may connect to other elements in the 5G CN 240 such as AMF 215. In some embodiments, WLAN 216 may support another RAT such as Bluetooth. The N3IWF 250 may provide support for secure access by UE 105 to other elements in 5G CN 240 and/or may support interworking of one or more protocols used by WLAN 216 and UE 105 to one or more protocols used by other elements of 5G CN 240 such as AMF 215. For example, N3IWF 250 may support IPSec tunnel establishment with UE 105, termination of IKEv2/IPSec protocols with UE 105, termination of N2 and N3 interfaces to 5G CN 240 for control plane and user plane, respectively, relaying of uplink (UL) and downlink (DL) control plane Non-Access Stratum (NAS) signaling between UE 105 and AMF 215 across an N1 interface. In some other embodiments, WLAN 216 may connect directly to elements in 5G CN 240 (e.g. AMF 215 as shown by the dashed line in FIG. 2) and not via N3IWF 250. For example, direct connection of WLAN 216 to 5GCN 240 may occur if WLAN 216 is a trusted WLAN for 5GCN 240 and may be enabled using a Trusted WLAN Interworking Function (TWIF) (not shown in FIG. 2) which may be an element inside WLAN 216. It is noted that while only one WLAN 216 is shown in FIG. 2, some embodiments may include multiple WLANs 216.

Access nodes may comprise any of a variety of network entities enabling communication between the UE 105 and the AMF 215. As noted, this can include gNBs 210, ng-eNB 214, WLAN 216, and/or other types of cellular base stations. However, access nodes providing the functionality described herein may additionally or alternatively include entities enabling communications to any of a variety of RATs not illustrated in FIG. 2, which may include non-cellular technologies. Thus, the term “access node,” as used in the embodiments described herein below, may include but is not necessarily limited to a gNB 210, ng-eNB 214 or WLAN 216.

In some embodiments, an access node, such as a gNB 210, ng-eNB 214, and/or WLAN 216 (alone or in combination with other components of the 5G NR positioning system 200), may be configured to, in response to receiving a request for location information from the LMF 220, obtain location measurements of uplink (UL) signals received from the UE 105) and/or obtain downlink (DL) location measurements from the UE 105 that were obtained by UE 105 for DL signals received by UE 105 from one or more access nodes. As noted, while FIG. 2 depicts access nodes (gNB 210, ng-eNB 214, and WLAN 216) configured to communicate according to 5G NR, LTE, and Wi-Fi communication protocols, respectively, access nodes configured to communicate according to other communication protocols may be used, such as, for example, a Node B using a Wideband Code Division Multiple Access (WCDMA) protocol for a Universal Mobile Telecommunications Service (UMTS) Terrestrial Radio Access Network (UTRAN), an eNB using an LTE protocol for an Evolved UTRAN (E-UTRAN), or a Bluetooth® beacon using a Bluetooth protocol for a WLAN. For example, in a 4G Evolved Packet System (EPS) providing LTE wireless access to UE 105, a RAN may comprise an E-UTRAN, which may comprise base stations comprising eNBs supporting LTE wireless access. A core network for EPS may comprise an Evolved Packet Core (EPC). An EPS may then comprise an E-UTRAN plus an EPC, where the E-UTRAN corresponds to NG-RAN 235 and the EPC corresponds to 5GCN 240 in FIG. 2. The methods and techniques described herein for obtaining a civic location for UE 105 may be applicable to such other networks.

The gNBs 210 and ng-eNB 214 can communicate with an AMF 215, which, for positioning functionality, communicates with an LMF 220. The AMF 215 may support mobility of the UE 105, including cell change and handover of UE 105 from an access node (e.g., gNB 210, ng-eNB 214, or WLAN 216) of a first RAT to an access node of a second RAT. The AMF 215 may also participate in supporting a signaling connection to the UE 105 and possibly data and voice bearers for the UE 105. The LMF 220 may support positioning of the UE 105 using a CP location solution when UE 105 accesses the NG-RAN 235 or WLAN 216 and may support position procedures and methods, including UE assisted/UE based and/or network based procedures/methods, such as Assisted GNSS (A-GNSS), Observed Time Difference Of Arrival (OTDOA) (which may be referred to in NR as Time Difference Of Arrival (TDOA)), Frequency Difference Of Arrival (FDOA), Real Time Kinematic (RTK), Precise Point Positioning (PPP), Differential GNSS (DGNSS), Enhance Cell ID (ECID), angle of arrival (AoA), angle of departure (AoD), WLAN positioning, round trip signal propagation delay (RTT), multi-cell RTT, and/or other positioning procedures and methods. The LMF 220 may also process location service requests for the UE 105, e.g., received from the AMF 215 or from the GMLC 225. The LMF 220 may be connected to AMF 215 and/or to GMLC 225. In some embodiments, a network such as 5GCN 240 may additionally or alternatively implement other types of location-support modules, such as an Evolved Serving Mobile Location Center (E-SMLC) or a SUPL Location Platform (SLP). It is noted that in some embodiments, at least part of the positioning functionality (including determination of a UE 105's location) may be performed at the UE 105 (e.g., by measuring downlink PRS (DL-PRS) signals transmitted by wireless nodes such as gNBs 210, ng-eNB 214 and/or WLAN 216, and/or using assistance data provided to the UE 105, e.g., by LMF 220).

The Gateway Mobile Location Center (GMLC) 225 may support a location request for the UE 105 received from an external client 230 and may forward such a location request to the AMF 215 for forwarding by the AMF 215 to the LMF 220. A location response from the LMF 220 (e.g., containing a location estimate for the UE 105) may be similarly returned to the GMLC 225 either directly or via the AMF 215, and the GMLC 225 may then return the location response (e.g., containing the location estimate) to the external client 230.

A Network Exposure Function (NEF) 245 may be included in 5GCN 240. The NEF 245 may support secure exposure of capabilities and events concerning 5GCN 240 and UE 105 to the external client 230, which may then be referred to as an Access Function (AF) and may enable secure provision of information from external client 230 to 5GCN 240. NEF 245 may be connected to AMF 215 and/or to GMLC 225 for the purposes of obtaining a location (e.g. a civic location) of UE 105 and providing the location to external client 230.

As further illustrated in FIG. 2, the LMF 220 may communicate with the gNBs 210 and/or with the ng-eNB 214 using an NR Positioning Protocol annex (NRPPa) as defined in 3GPP Technical Specification (TS) 38.455. NRPPa messages may be transferred between a gNB 210 and the LMF 220, and/or between an ng-eNB 214 and the LMF 220, via the AMF 215. As further illustrated in FIG. 2, LMF 220 and UE 105 may communicate using an LTE Positioning Protocol (LPP) as defined in 3GPP TS 37.355. Here, LPP messages may be transferred between the UE 105 and the LMF 220 via the AMF 215 and a serving gNB 210-1 or serving ng-eNB 214 for UE 105. For example, LPP messages may be transferred between the LMF 220 and the AMF 215 using messages for service-based operations (e.g., based on the Hypertext Transfer Protocol (HTTP)) and may be transferred between the AMF 215 and the UE 105 using a 5G NAS protocol. The LPP protocol may be used to support positioning of UE 105 using UE assisted and/or UE based position methods such as A-GNSS, RTK, TDOA, multi-cell RTT, AoD, and/or ECID. The NRPPa protocol may be used to support positioning of UE 105 using network based position methods such as ECID, AoA, uplink TDOA (UL-TDOA) and/or may be used by LMF 220 to obtain location related information from gNBs 210 and/or ng-eNB 214, such as parameters defining DL-PRS transmission from gNBs 210 and/or ng-eNB 214.

In the case of UE 105 access to WLAN 216, LMF 220 may use NRPPa and/or LPP to obtain a location of UE 105 in a similar manner to that just described for UE 105 access to a gNB 210 or ng-eNB 214. Thus, NRPPa messages may be transferred between a WLAN 216 and the LMF 220, via the AMF 215 and N3IWF 250 to support network-based positioning of UE 105 and/or transfer of other location information from WLAN 216 to LMF 220. Alternatively, NRPPa messages may be transferred between N3IWF 250 and the LMF 220, via the AMF 215, to support network-based positioning of UE 105 based on location related information and/or location measurements known to or accessible to N3IWF 250 and transferred from N3IWF 250 to LMF 220 using NRPPa. Similarly, LPP and/or LPP messages may be transferred between the UE 105 and the LMF 220 via the AMF 215, N3IWF 250, and serving WLAN 216 for UE 105 to support UE assisted or UE based positioning of UE 105 by LMF 220.

In a 5G NR positioning system 200, positioning methods can be categorized as being “UE assisted” or “UE based.” This may depend on where the request for determining the position of the UE 105 originated. If, for example, the request originated at the UE (e.g., from an application, or “app,” executed by the UE), the positioning method may be categorized as being UE based. If, on the other hand, the request originates from an external client 230, LMF 220, or other device or service within the 5G network, the positioning method may be categorized as being UE assisted (or “network-based”).

With a UE-assisted position method, UE 105 may obtain location measurements and send the measurements to a location server (e.g., LMF 220) for computation of a location estimate for UE 105. For RAT-dependent position methods location measurements may include one or more of a Received Signal Strength Indicator (RSSI), Round Trip signal propagation Time (RTT), Reference Signal Received Power (RSRP), Reference Signal Received Quality (RSRQ), Reference Signal Time Difference (RSTD), Time of Arrival (TOA), AoA, Receive Time-Transmission Time Difference (Rx-Tx), Differential AoA (DAoA), AoD, or Timing Advance (TA) for gNBs 210, ng-eNB 214, and/or one or more access points for WLAN 216. Additionally or alternatively, similar measurements may be made of sidelink signals transmitted by other UEs, which may serve as anchor points for positioning of the UE 105 if the positions of the other UEs are known. The location measurements may also or instead include measurements for RAT-independent positioning methods such as GNSS (e.g., GNSS pseudorange, GNSS code phase, and/or GNSS carrier phase for satellites 110), WLAN, etc.

With a UE-based position method, UE 105 may obtain location measurements (e.g., which may be the same as or similar to location measurements for a UE assisted position method) and may further compute a location of UE 105 (e.g., with the help of assistance data received from a location server such as LMF 220, an SLP, or broadcast by gNBs 210, ng-eNB 214, or WLAN 216).

With a network based position method, one or more base stations (e.g., gNBs 210 and/or ng-eNB 214), one or more APs (e.g., in WLAN 216), or N3IWF 250 may obtain location measurements (e.g., measurements of RSSI, RTT, RSRP, RSRQ, AoA, or TOA) for signals transmitted by UE 105, and/or may receive measurements obtained by UE 105 or by an AP in WLAN 216 in the case of N3IWF 250, and may send the measurements to a location server (e.g., LMF 220) for computation of a location estimate for UE 105.

Positioning of the UE 105 also may be categorized as UL, DL, or DL-UL based, depending on the types of signals used for positioning. If, for example, positioning is based solely on signals received at the UE 105 (e.g., from a base station or other UE), the positioning may be categorized as DL based. On the other hand, if positioning is based solely on signals transmitted by the UE 105 (which may be received by a base station or other UE, for example), the positioning may be categorized as UL based. Positioning that is DL-UL based includes positioning, such as RTT-based positioning, that is based on signals that are both transmitted and received by the UE 105. Sidelink (SL)-assisted positioning comprises signals communicated between the UE 105 and one or more other UEs. According to some embodiments, UL, DL, or DL-UL positioning as described herein may be capable of using SL signaling as a complement or replacement of SL, DL, or DL-UL signaling.

Depending on the type of positioning (e.g., UL, DL, or DL-UL based) the types of reference signals used can vary. For DL-based positioning, for example, these signals may comprise PRS (e.g., DL-PRS transmitted by base stations or SL-PRS transmitted by other UEs), which can be used for TDOA, AoD, and RTT measurements. Other reference signals that can be used for positioning (UL, DL, or DL-UL) may include Sounding Reference Signal (SRS), Channel State Information Reference Signal (CSI-RS), synchronization signals (e.g., synchronization signal block (SSB) Synchronizations Signal (SS)), Physical Uplink Control Channel (PUCCH), Physical Uplink Shared Channel (PUSCH), Physical Sidelink Shared Channel (PSSCH), Demodulation Reference Signal (DMRS), etc. Moreover, reference signals may be transmitted in a Tx beam and/or received in an Rx beam (e.g., using beamforming techniques), which may impact angular measurements, such as AoD and/or AoA.

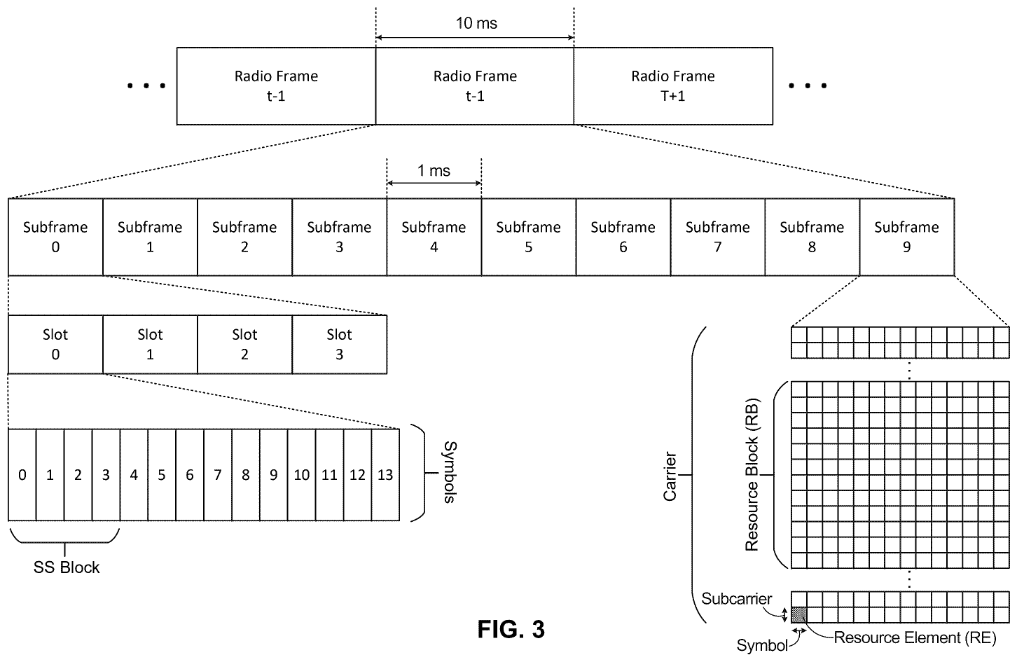

FIG. 3 is a diagram showing an example of a frame structure for NR and associated terminology, which can serve as the basis for physical layer communication between the UE 105 and base stations/TRPs. The transmission timeline for each of the downlink and uplink may be partitioned into units of radio frames. Each radio frame may have a predetermined duration (e.g., 10 ms) and may be partitioned into 10 subframes, each of 1 ms, with indices of 0 through 9. Each subframe may include a variable number of slots depending on the subcarrier spacing. Each slot may include a variable number of symbol periods (e.g., 7 or 14 symbols) depending on the subcarrier spacing. The symbol periods in each slot may be assigned indices. A mini slot may comprise a sub slot structure (e.g., 2, 3, or 4 symbols). Additionally shown in FIG. 3 is the complete Orthogonal Frequency-Division Multiplexing (OFDM) of a subframe, showing how a subframe can be divided across both time and frequency into a plurality of Resource Blocks (RBs). A single RB can comprise a grid of Resource Elements (REs) spanning 14 symbols and 12 subcarriers.

Each symbol in a slot may indicate a link direction (e.g., downlink (DL), uplink (UL), or flexible) or data transmission and the link direction for each subframe may be dynamically switched. The link directions may be based on the slot format. Each slot may include DL/UL data as well as DL/UL control information. In NR, a synchronization signal block (SSB) is transmitted. The SSB includes a primary synchronization signal (PSS), a secondary synchronization signal (SSS), and a two symbol Physical Broadcast Channel (PBCH). The SSB can be transmitted in a fixed slot location, such as the symbols 0-3 as shown in FIG. 3. The PSS and SSS may be used by UEs for cell search and acquisition. The PSS may provide half-frame timing, the SS may provide the cyclic prefix (CP) length and frame timing. The PSS and SSS may provide the cell identity. The PBCH carries some basic system information, such as downlink system bandwidth, timing information within radio frame, SS burst set periodicity, system frame number, etc.

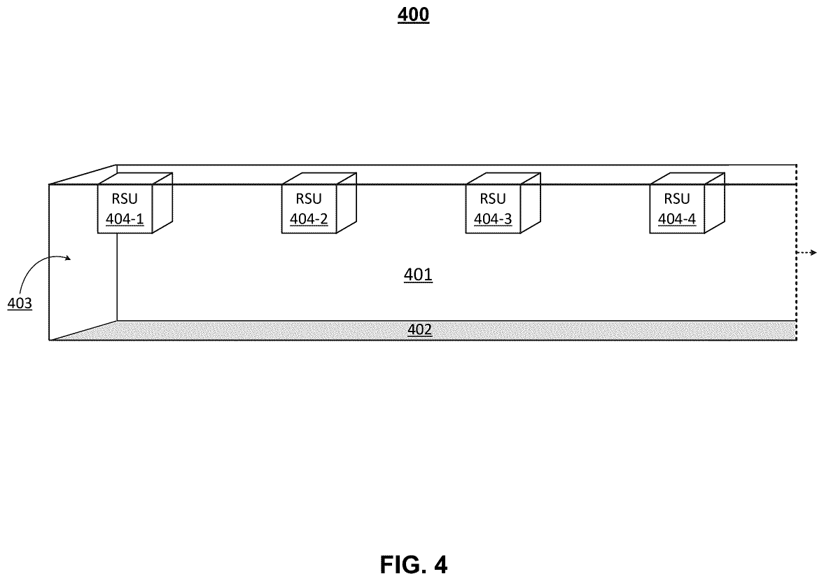

FIG. 4 illustrates an example wireless communication system 400. Wireless communication system 400 consists of a plurality of road-side units (RSUs) 404-1, 404-2, 404-3, and 404-4 arranged within an enclosed space 401. A roadway 402 extends along a bottom surface of enclosed space 401, allowing vehicles to pass through enclosed space 401. According to aspects of the disclosure, RSUs 404-1, 404-2, 404-3, and 404-4 can be capable of communicating with on-board units (OBUs) of vehicles that pass through enclosed space 401 on roadway 402. In some implementations, RSUs 404-1, 404-2, 404-3, and 404-4 can communicate with OBUs of passing vehicles in conjunction with the provision of wireless data connectivity to such vehicles.

According to aspects of the disclosure, RSUs 404-1, 404-2, 404-3, and 404-4 can be vehicle-to-everything (V2X) RSUs configured to communicate with V2X OBUs of passing vehicles according to one or more V2X communication standards and/or protocols. For instance, in some implementations, RSUs 404-1, 404-2, 404-3, and 404-4 can be configured to communicate according to V2X communication standards and/or protocols defined in one or more technical standards (TSs) and/or technical reports (TRs) published by the Third Generation Partnership Project (3GPP) and or European Telecommunications Standards Institute (ETSI). According to aspects of the disclosure, one or more of RSUs 404-1, 404-2, 404-3, and 404-4 can be implemented as UEs, any or all of which may be the same as or similar to UE 105 of FIG. 1. In some implementations, one or more of RSUs 404-1, 404-2, 404-3, and 404-4 can be implemented as base stations, any or all of which may be the same as or similar to base station 120 of FIG. 1 or gNBs 210 of FIG. 2.

According to aspects of the disclosure, enclosed space 401 can be a tunnel, such as a vehicular tunnel that provides passage for roadway 402 underground or through an obstacle (such as a mountain or building, for instance). In some implementations, as shown in FIG. 4, RSUs 404-1, 404-2, 404-3, and 404-4 can be suspended from an upper surface (such as a ceiling) of enclosed space 401. RSU 404-1 is positioned closest to an open end 403 of enclosed space 401, and RSUs 404-2, 404-3, and 404-4 are positioned successively further away from the open end 403. In some implementations, the distances between successive ones of RSUs 404-1, 404-2, 404-3, and 404-4 can be in the approximate range of 100 to 300 meters. As reflected by the dashed arrow in FIG. 4, enclosed space 401 may extend further than illustrated in FIG. 4, and the plurality of RSUs in wireless communication system 400 may include addition RSUs positioned along portions of enclosed space 401 not shown in FIG. 4.

According to aspects of the disclosure, in order to support wireless communications with OBUs of vehicles passing through enclosed space 401, RSUs 404-1, 404-2, 404-3, and 404-4 may perform synchronization operations to establish synchronization among timings of those RSUs and between the timings of those RSUs and those of OBUs of passing vehicles. In some implementations, RSUs 404-1, 404-2, 404-3, and 404-4 may be configured to synchronize their timings with timings indicated by received synchronization signals, and to transmit synchronization signals that indicate those timings. According to aspects of the disclosure, each of RSUs 404-1, 404-2, 404-3, and 404-4 can select a synchronization reference source, and can synchronize its timing with a timing indicated by a received synchronization signal corresponding to that synchronization reference source. According to aspects of the disclosure, possible synchronization references that a given one of RSUs 404-1, 404-2, 404-3, and 404-4 can be capable of using as its synchronization reference source can include a global navigation satellite system (GNSS) as well as other RSUs. Herein, the term SyncRef RSU is used to denote an RSU that is used by another RSU as a synchronization reference source.

According to aspects of the disclosure, RSUs 404-1, 404-2, 404-3, and 404-4 can be configured to follow a priority scheme in selecting the synchronization references that they use as synchronization reference sources. In some implementations, according to the priority scheme, GNSS references can be afforded a higher priority than RSU references, such that if a GNSS reference is available to an RSU, the RSU will select that GNSS reference over any RSU reference(s) that may be available to the RSU for use as synchronization reference sources. Among RSU references, RSUs references corresponding to RSUs using GNSS references as their synchronization reference sources can be afforded higher priority than RSU references corresponding to RSUs using other RSU references as their synchronization reference sources.

According to aspects of the disclosure, RSUs 404-1, 404-2, 404-3, and 404-4 can be configured to use alternate synchronization references as their synchronization reference sources when their currently-used references become unavailable. In some cases, this may involve using a reference of a lower priority than that of the reference that has been lost. For instance, if a given one of RSUs 404-1, 404-2, 404-3, and 404-4 is using a GNSS reference as its synchronization reference source, and the GNSS reference becomes unavailable, that RSU may adopt an RSU reference corresponding to another RSU as its synchronization reference source.

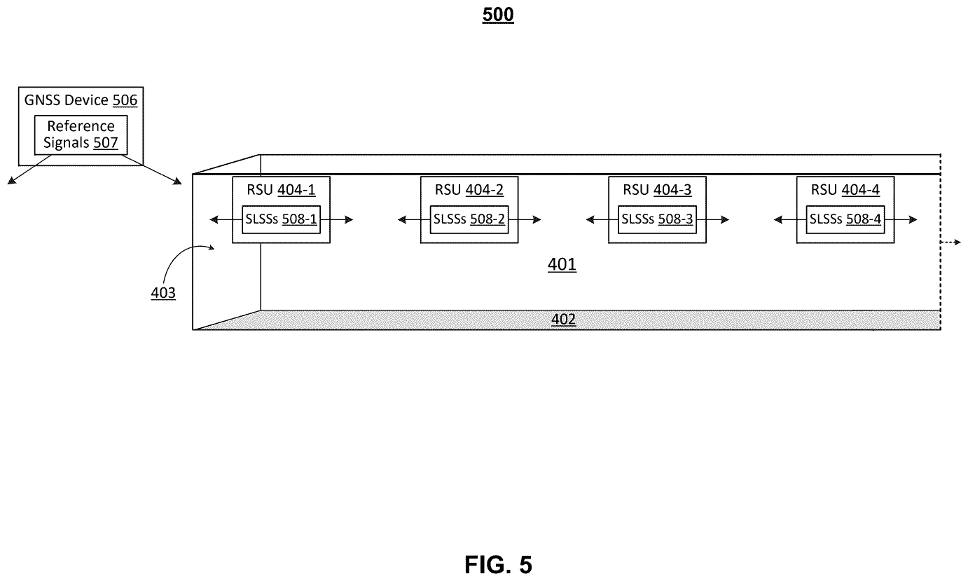

FIG. 5 illustrates an example operating environment 500. In operating environment 500, RSUs 404-1, 404-2, 404-3, and 404-4 implement a synchronization chain. Implementation of the synchronization chain can allow some RSUs of communication system 400 of FIG. 4 to synchronize their timings with that of a GNSS reference that is not directly available to them, by propagating the GNSS reference timing from an RSU to which the GNSS reference is available.

In the example of FIG. 5, by virtue of being positioned near the open end 403 of enclosed space 401 in FIG. 4, RSU 404-1 is able to receive reference signals 507 transmitted on a wireless carrier by a GNSS device 506 (which can be, for example, a satellite transmitter). As such, a GNSS reference is available for use as a synchronization reference source by RSU 404-1, which can synchronize with that GNSS reference according to timing indicated by reference signals 507. RSUs 404-2, 404-3, and 404-4, which are positioned further from the open end 403 of enclosed space 401, may be unable to receive reference signals 507 or any other GNSS reference signals. Thus, no GNSS reference may be available for use as a synchronization reference source by RSUs 404-2, 404-3, or 404-4.

To allow other RSUs to synchronize with the GNSS timing indicated by reference signals 507, RSU 404-1 can transmit sidelink synchronization signals (SLSSs) 508-1 on the wireless carrier. RSU 404-2, the closest RSU to RSU 404-1, may be able to receive SLSSs 508-1, and thus may be able to use RSU 404-1 as a synchronization reference source. RSU 404-2 can synchronize with RSU 404-1—and thus with the GNSS reference corresponding to reference signals 507—according to timing indicated by SLSSs 508-1.

Similarly, RSU 404-2 may transmit SLSSs 508-2 on the wireless carrier, and RSU 404-3 may receive SLSSs 508-2 and use RSU 404-2 as a synchronization reference source by synchronizing with timing indicated by SLSSs 508-2. In turn, RSU 404-3 may transmit SLSSs 508-3 on the wireless carrier, and RSU 404-4 may receive SLSSs 508-3 and use RSU 404-3 as a synchronization reference source by synchronizing with timing indicated by SLSSs 508-3. RSU 404-4 may transmit SLSSs 508-4 to enable a next RSU (not shown) in the synchronization chain to synchronize with the preceding RSUs and thus with the GNSS source.

According to aspects of the disclosure, transmission of SLSSs 508-1, 508-2, 508-3, and 508-4 by respective RSUs 404-1, 404-2, 404-3, and 404-4 may involve transmission of sidelink SSBs (S-SSBs) that are similar to the SSB discussed above in reference to the NR frame structure of FIG. 3. Similar to the SSB of FIG. 3, which includes a PSS, an SSS, and a two-symbol PBCH, an S-SSB corresponding to an SLSS 508-1, 508-2, 508-3, or 508-4 can consist of a sidelink PSS (S-PSS), a sidelink SSS (S-SSS), and a multi-symbol physical sidelink broadcast channel (PSBCH). The S-SSB can occupy a full slot, and the S-PSS and S-SSS can occupy two symbols each within that slot.

It is worthy of note that some RSUs in the synchronization chain in operating environment 500 may be able to receive reference signals (such as GNSS reference signals and/or SLSSs) associated with multiple synchronization references. For instance, RSU 404-1 may be able to receive both the reference signals 507 transmitted by GNSS device 506 and the SLSSs 508-2 transmitted by RSU 404-2. Similarly, RSU 404-2 may be able to receive both the SLSSs 508-1 transmitted by RSU 404-1 and the SLSSs 508-3 transmitted by RSU 404-3, and RSU 404-3 may be able to receive both the SLSSs 508-2 transmitted by RSU 404-2 and the SLSSs 508-4 transmitted by RSU 404-4.

According to aspects of the disclosure, RSUs in operating environment 500 that can receive reference signals (such as GNSS reference signals and/or SLSSs) associated with multiple synchronization references can choose among the multiple synchronization references according to a priority scheme such as discussed above in reference to FIG. 4. For instance, the priority scheme can afford higher priority to GNSS references than to RSU references, and thus RSU 404-1 can use the GNSS reference as its synchronization reference source rather than using RSU 404-2 as a SyncRef RSU. In another example, the priority scheme can afford higher priority to SyncRef RSUs that use GNSS references as their synchronization reference sources than to SyncRef RSUs that use SyncRef RSUs as their synchronization reference sources, and thus RSU 404-2 can use RSU 404-1 as a SyncRef RSU rather than using RSU 404-3 as a SyncRef RSU.

According to aspects of the disclosure, RSUs in operating environment 500 can be configured to use alternate synchronization references as their synchronization reference sources when their currently-used references become available. If multiple alternate synchronization references are available to a given RSU, it may select from among those multiple alternate sources based on factors that can include the respective priorities of the multiple alternate sources according to a priority scheme. An RSU having only one alternate synchronization reference available to it may adopt that alternate reference upon its currently-used reference becoming unavailable.

In some implementations, each of RSUs 404-1, 404-2, 404-3, and 404-4 may have one respective synchronization reference available for potential adoption in the event that it loses the synchronization reference that it uses in conjunction with propagating the timing of the GNSS reference along the synchronization chain in operating environment 500. For instance, RSU 404-2 may be available for use as a SyncRef RSU by RSU 404-1 as an alternative to the GNSS reference, RSU 404-3 may be available for use as a SyncRef RSU by RSU 404-2 as an alternative to the use of RSU 404-1, and RSU 404-4 may be available for use as a SyncRef RSU by RSU 404-3 as an alternative to the use of RSU 404-2. According to aspects of the disclosure, RSUs 404-1, 404-2, 404-3, and 404-4 can be configured to, upon loss of their currently-used synchronization references, adopt their alternate synchronization references as their synchronization reference sources, monitor the wireless carrier for reference signals (such as GNSS reference signals and/or SLSSs) associated with their alternate synchronization references, and transmit SLSSs on the wireless carrier according to timings indicated by those reference signals.

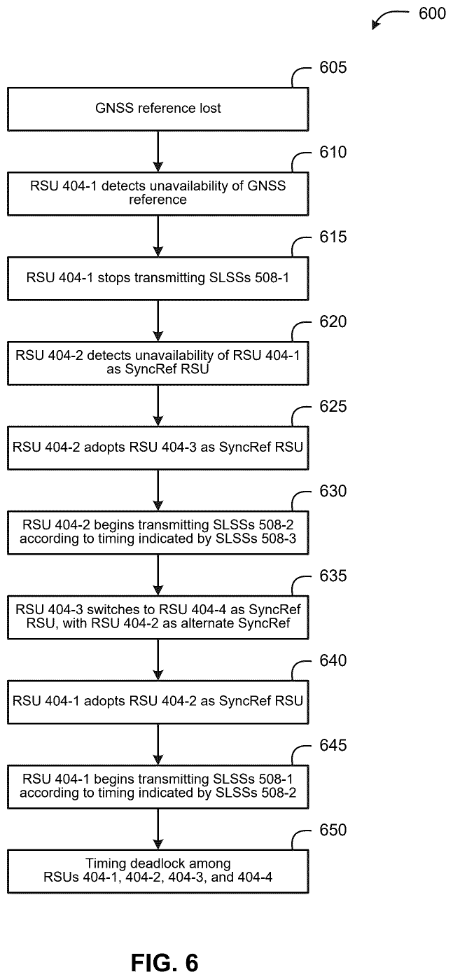

In operating environment 500, the potential may exist for a timing deadlock to form among RSUs 404-1, 404-2, 404-3, and 404-4 if the GNSS reference becomes unavailable to RSU 404-1 (because, for example, GNSS device 506 stops transmitting reference signals 507, or weather conditions or other obstruction(s) prevent reference signals 507 from reaching RSU 404-1). FIG. 6 is a block diagram of an example event flow 600 that illustrates a manner in which a loss of the GNSS reference in operating environment 500 of FIG. 5 may lead to a timing deadlock.

When event flow 600 begins, the synchronization references available to RSU 404-1 may be the GNSS reference and SyncRef RSU 404-2, the synchronization references available to RSU 404-2 may be SyncRef RSUs 404-1 and 404-3, and the synchronization references available to RSU 404-3 may be SyncRef RSUs 404-2 and 404-4. RSU 404-1 may be using the GNSS reference as its synchronization reference source due to a higher priority of the GNSS reference relative to that of SyncRef RSU 404-2. RSU 404-2 may be using SyncRef RSU 404-1 as its synchronization reference source due to a higher priority of SyncRef RSU 404-1 relative to that of SyncRef RSU 404-3. RSU 404-3 may be using SyncRef RSU 404-2 as its synchronization reference source due to a higher priority of SyncRef RSU 404-2 relative to that of SyncRef RSU 404-4.

According to event flow 600, the GNSS reference associated with the reference signals 507 transmitted by GNSS device 506 may be lost at block 605. As noted above, loss of this GNSS reference may occur, for example, if GNSS device 506 stops transmitting reference signals 507, or if weather conditions or other obstruction(s) prevent reference signals 507 from reaching RSU 404-1. At block 610, RSU 404-1 may detect the unavailability of the GNSS reference. Responsive to detecting the unavailability of the GNSS reference, RSU 404-1 may stop transmitting SLSSs 508-1 at block 615.

At block 620, RSU 404-2 may detect (based on the absence of SLSSs 508-1 on the wireless carrier) the unavailability of RSU 404-1 as a SyncRef RSU. Responsive to detecting the unavailability of RSU 404-1 as a SyncRef RSU, RSU 404-2 may adopt RSU 404-3 as a SyncRef RSU at block 625. At block 630, having adopted RSU 404-3 as a SyncRef RSU, RSU 404-2 may begin transmitting SLSSs 508-2 according to a timing indicated by SLSSs 508-3 transmitted by RSU 404-3. These SLSSs 508-2 may be the same as the SLSSs 508-4 transmitted by RSU 404-4, which also uses RSU 404-3 as a SyncRef RSU.

At block 635, RSU 404-3 may switch from using RSU 404-2 to using RSU 404-4 as its SyncRef RSU, and based on SLSSs 508-2 transmitted by RSU 404-2 starting at block 630, may identify RSU 404-2 as an alternate, lower-priority SyncRef RSU. This switch may not cause a change in the SLSSs 508-3 transmitted by RSU 404-3.

At block 640, able to receive only the SLSSs 508-2 transmitted by RSU 404-2, RSU 404-1 may adopt RSU 404-2 as its SyncRef RSU. At block 645, RSU 404-1 may begin transmitting SLSSs 508-1 according to a timing indicated by SLSSs 508-2. This timing may correspond to the timing indicated by SLSSs 508-3, which in turn may correspond to the timing indicated by SLSSs 508-4. As such, at block 650, there may be a timing deadlock among RSUs 404-1, 404-2, 404-3, and 404-4.

Disclosed herein are deadlock prevention techniques that may be implemented to prevent timing deadlock in RSU synchronization chains, such as that of operating environment 500 of FIG. 5, in the event of GNSS reference unavailability. According to such deadlock prevention techniques, RSUs of an RSU synchronization chain (for example, RSUs 404-1, 404-2, 404-3, and 404-4) can be configured to initiate a wait interval upon switching their synchronization reference sources. In some implementations, the RSUs can be configured to initiate the wait interval upon switching from higher priority synchronization references to lower priority synchronization references. An RSU initiating the wait interval upon switching to a different synchronization reference can pause its SLSS transmissions for the duration of the wait interval. Following expiration of the wait interval, the RSU can check for reference signals associated with the newly-adopted synchronization reference. If reference signals associated with the newly-adopted synchronization reference are found, the RSU can resume SLSS transmissions (according to a timing indicated by those reference signals). If reference signals associated with the newly-adopted synchronization reference are not found, the RSU can continue to refrain from transmitting SLSSs.

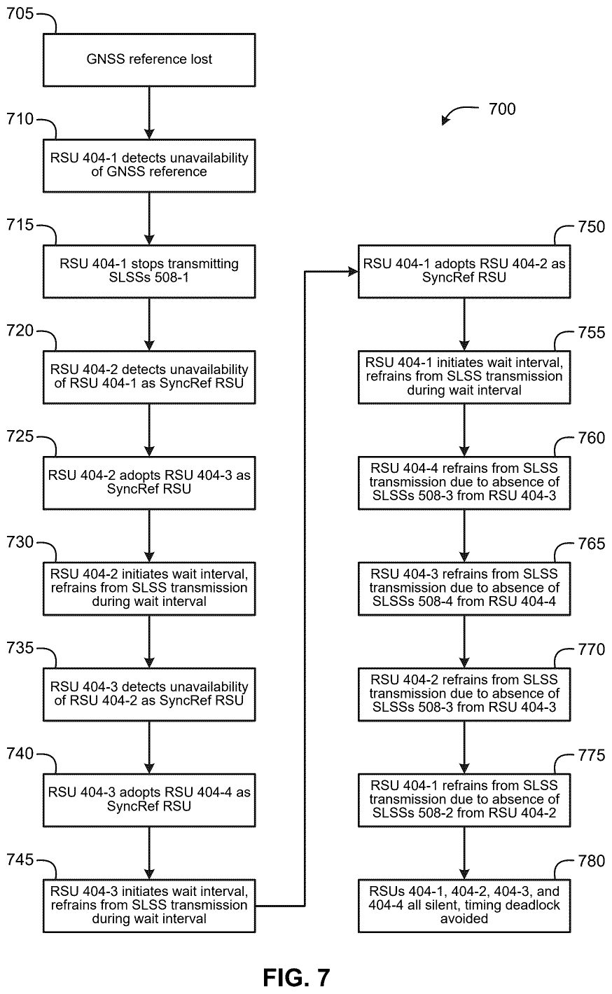

FIG. 7 is a block diagram of an example event flow 700 that may be representative of the implementation of the disclosed deadlock prevention techniques in operating environment 500 of FIG. 5 according to aspects of the disclosure. Prior to the beginning of event flow 700, RSUs 404-1, 404-2, 404-3, and 404-4 may each be configured to initiate wait intervals upon switching synchronization references. In some implementations, implementation of such wait intervals may be limited to synchronization reference source changes involving switching from higher-priority references to lower-priority references. In other implementations, such wait intervals may also be implemented in circumstances involving switching between synchronization sources of like priority. In still other implementations, such wait intervals may be implemented in conjunction with all synchronization reference source changes, without regard for the priorities of the newly-adopted synchronization references relative to the previously-utilized synchronization references.

When event flow 700 begins, the synchronization references available to RSU 404-1 may be the GNSS reference and SyncRef RSU 404-2, the synchronization references available to RSU 404-2 may be SyncRef RSUs 404-1 and 404-3, and the synchronization references available to RSU 404-3 may be SyncRef RSUs 404-2 and 404-4. RSU 404-1 may be using the GNSS reference as its synchronization reference source due to a higher priority of the GNSS reference relative to that of SyncRef RSU 404-2. RSU 404-2 may be using SyncRef RSU 404-1 as its synchronization reference source due to a higher priority of SyncRef RSU 404-1 relative to that of SyncRef RSU 404-3. RSU 404-3 may be using SyncRef RSU 404-2 as its synchronization reference source due to a higher priority of SyncRef RSU 404-2 relative to that of SyncRef RSU 404-4.

According to event flow 700, the GNSS reference associated with the reference signals 507 transmitted by GNSS device 506 may be lost at block 705. As previously noted, loss of this GNSS reference may occur, for example, if GNSS device 506 stops transmitting reference signals 507, or if weather conditions or other obstruction(s) prevent reference signals 507 from reaching RSU 404-1. At block 710, RSU 404-1 may detect the unavailability of the GNSS reference. Responsive to detecting the unavailability of the GNSS reference, RSU 404-1 may stop transmitting SLSSs 508-1 at block 715.

At block 720, RSU 404-2 may detect (based on the absence of SLSSs 508-1 on the wireless carrier) the unavailability of RSU 404-1 as a SyncRef RSU. Responsive to detecting the unavailability of RSU 404-1 as a SyncRef RSU, RSU 404-2 may adopt RSU 404-3 as a SyncRef RSU at block 725. At block 730, due to its having switched from using RSU 404-1 to using RSU 404-3 as a SyncRef RSU, RSU 404-2 may initiate a wait interval, during which it may refrain from transmitting SLSSs 508-2.

At block 735, RSU 404-3 may detect (based on the absence of SLSSs 508-2 on the wireless carrier) the unavailability of RSU 404-2 as a SyncRef RSU. Responsive to detecting the unavailability of RSU 404-2 as a SyncRef RSU, RSU 404-3 may adopt RSU 404-4 as a SyncRef RSU at block 740. At block 745, due to its having switched from using RSU 404-2 to using RSU 404-4 as a SyncRef RSU, RSU 404-3 may initiate a wait interval, during which it may refrain from transmitting SLSSs 508-3.

At block 750, able to receive only SLSSs 508-2 transmitted by RSU 404-2, RSU 404-1 may adopt RSU 404-2 as a SyncRef RSU. At block 755, due to its having switched from using the GNSS reference to using RSU 404-2 as a SyncRef RSU, RSU 404-1 may initiate a wait interval, during which it may refrain from transmitting SLSSs 508-1.

At block 760, due to an absence of SLSSs 508-3 of RSU 404-3 from the wireless carrier, RSU 404-4 may refrain from transmitting SLSSs 508-4 on the wireless carrier. At block 765, due to an absence of SLSSs 508-4 of RSU 404-4 from the wireless carrier, RSU 404-3 may refrain from transmitting SLSSs 508-3 on the wireless carrier. At block 770, due to an absence of SLSSs 508-3 of RSU 404-3 from the wireless carrier, RSU 404-2 may refrain from transmitting SLSSs 508-2 on the wireless carrier. At block 775, due to an absence of SLSSs 508-2 of RSU 404-2 from the wireless carrier, RSU 404-1 may refrain from transmitting SLSSs 508-1 on the wireless carrier. At block 780, RSUs 404-1, 404-2, 404-3, and 404-4 may all be silent (refraining from SLSS transmission), and thus timing deadlock may be avoided.

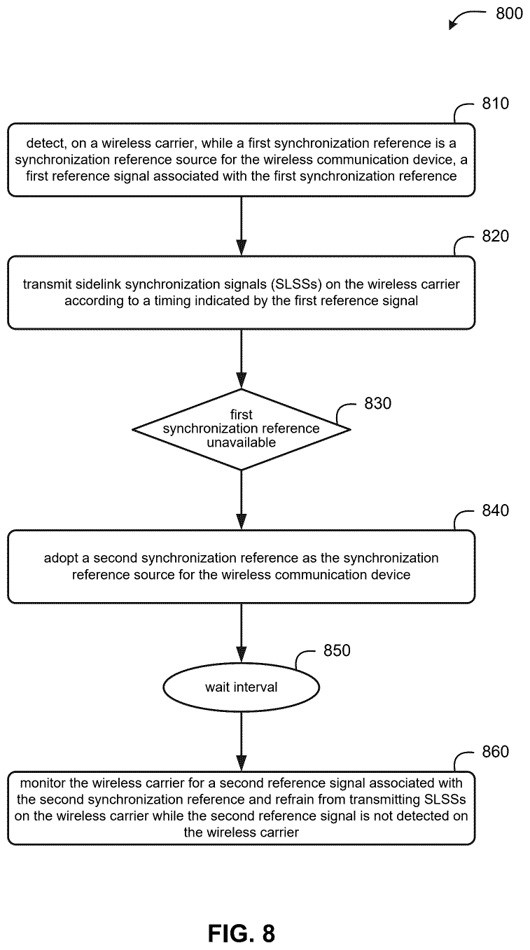

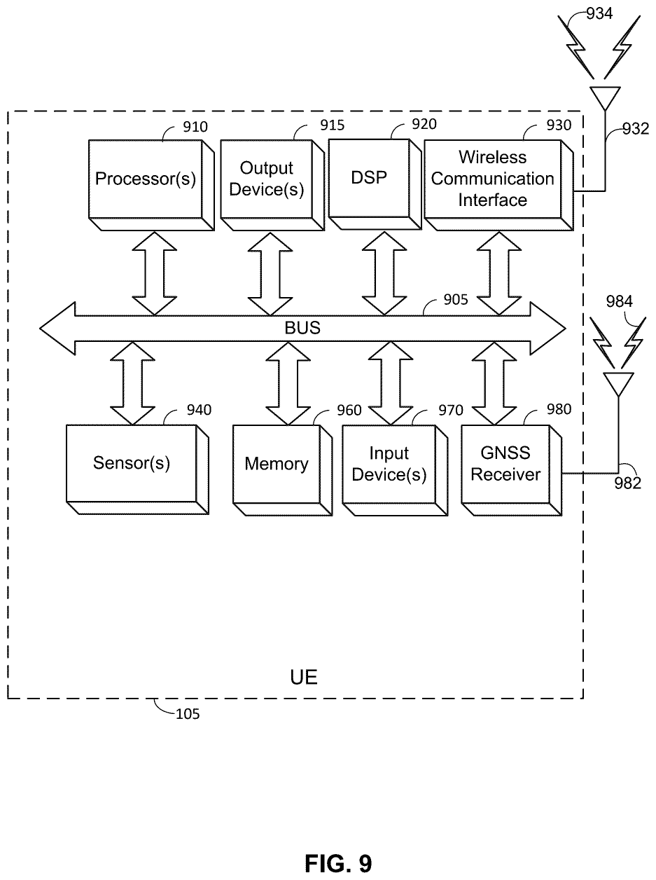

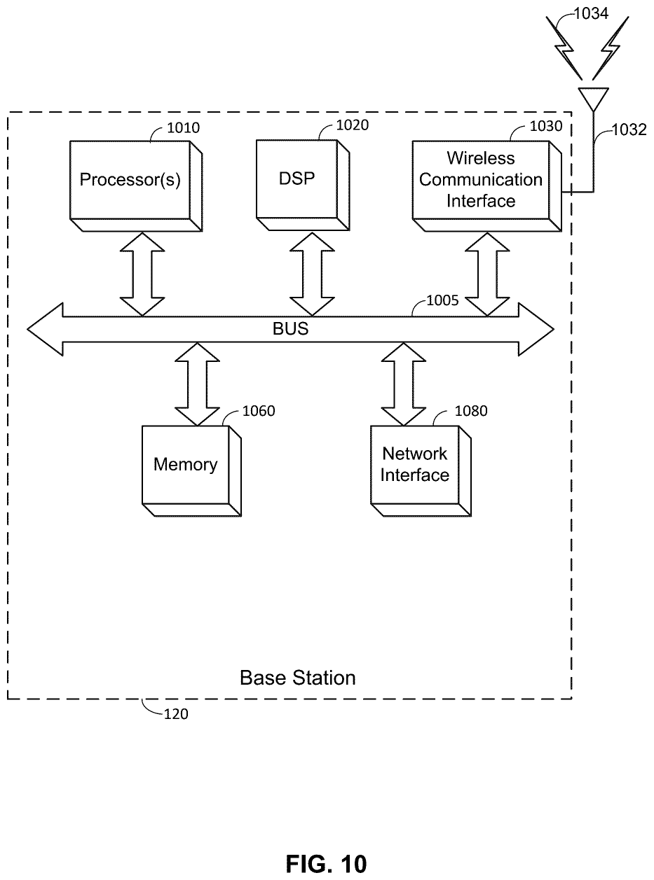

FIG. 8 is a flow diagram of a method 800 of wireless communication by a wireless communication device, according to an embodiment. Means for performing the functionality illustrated in one or more of the blocks shown in FIG. 8 may be performed by hardware and/or software components of an RSU, such as any of RSUs 404-1, 404-2, 404-3, and 404-4 of FIGS. 4 and 5. In some implementations, such an RSU may be implemented as a UE or a base station (such as a gNB), example components of which are illustrated in FIG. 9 and FIG. 10, respectively, which are described in more detail below.

At block 810, the functionality comprises detecting, by a wireless communication device, on a wireless carrier, while a first synchronization reference is a synchronization reference source for the wireless communication device, a first reference signal associated with the first synchronization reference. For example, in operating environment 500 of FIG. 5, RSU 404-2 can detect SLSSs 508-1 on a wireless carrier while RSU 404-1 is a SyncRef RSU that RSU 404-2 uses as its synchronization reference source. According to some implementations, means for performing functionality at block 810 may comprise a bus 905, processors 910, digital signal processor (DSP) 920, wireless communication interface 930, memory 960, and/or other components of a UE, as illustrated in FIG. 9. According to some other implementations, means for performing functionality at block 810 may comprise a bus 1005, processors 1010, DSP 1020, wireless communication interface 1030, memory 1060, and/or other components of a base station, as illustrated in FIG. 10.

At block 820, the functionality comprises transmitting SLSSs on the wireless carrier according to a timing indicated by the first reference signal. For example, in operating environment 500 of FIG. 5, RSU 404-2 can transmit SLSSs 508-2 on the wireless carrier according to a timing indicated by SLSSs 508-1. According to some implementations, means for performing functionality at block 820 may comprise a bus 905, processors 910, DSP 920, wireless communication interface 930, memory 960, and/or other components of a UE, as illustrated in FIG. 9. According to some other implementations, means for performing functionality at block 810 may comprise a bus 1005, processors 1010, DSP 1020, wireless communication interface 1030, memory 1060, and/or other components of a base station, as illustrated in FIG. 10.

At block 830, the functionality comprises determining that the first synchronization reference has become unavailable. For example, in operating environment 500 of FIG. 5, RSU 404-2 can determine that RSU 404-1 is no longer available as a SyncRef RSU (based, for example, on an inability to detect and/or receive SLSSs 508-1 via the wireless carrier). According to some implementations, means for performing functionality at block 830 may comprise a bus 905, processors 910, DSP 920, wireless communication interface 930, memory 960, and/or other components of a UE, as illustrated in FIG. 9. According to some other implementations, means for performing functionality at block 810 may comprise a bus 1005, processors 1010, DSP 1020, wireless communication interface 1030, memory 1060, and/or other components of a base station, as illustrated in FIG. 10.

At block 840, the functionality comprises, responsive to the determination at block 830 that the first synchronization reference has become unavailable, adopting a second synchronization reference as the synchronization reference source for the wireless communication device. For example, in operating environment 500 of FIG. 5, responsive to determining that RSU 404-1 is no longer available as a SyncRef RSU, RSU 404-2 can adopt RSU 404-3 as a SyncRef RSU that serves as the synchronization reference source for RSU 404-2. According to some implementations, means for performing functionality at block 840 may comprise a bus 905, processors 910, DSP 920, wireless communication interface 930, memory 960, and/or other components of a UE, as illustrated in FIG. 9. According to some other implementations, means for performing functionality at block 810 may comprise a bus 1005, processors 1010, DSP 1020, wireless communication interface 1030, memory 1060, and/or other components of a base station, as illustrated in FIG. 10.

At block 850, the functionality comprises initiating a wait interval due to the switch to a different synchronization reference at block 840. For example, in operating environment 500 of FIG. 5, RSU 404-2 can initiate a wait interval due to a switch from RSU 404-1 to RSU 404-3 as the SyncRef RSU that serves as the synchronization reference source for RSU 404-2. According to some implementations, means for performing functionality at block 850 may comprise a bus 905, processors 910, DSP 920, wireless communication interface 930, memory 960, and/or other components of a UE, as illustrated in FIG. 9. According to some other implementations, means for performing functionality at block 810 may comprise a bus 1005, processors 1010, DSP 1020, wireless communication interface 1030, memory 1060, and/or other components of a base station, as illustrated in FIG. 10.

At block 860, the functionality comprises, following expiration of the wait interval initiated at block 850, monitoring the wireless carrier for a second reference signal associated with the second synchronization reference and refraining from transmitting SLSSs on the wireless carrier while the second reference signal is not detected on the wireless carrier. For example, in operating environment 500 of FIG. 5, following expiration of a wait interval initiated due to a switch from RSU 404-1 to RSU 404-3 as the SyncRef RSU that serves as the synchronization reference source for RSU 404-2, RSU 404-2 can monitor the wireless carrier for SLSSs 508-3 associated with RSU 404-3 and can refrain from transmitting SLSSs 508-2 on the wireless carrier while SLSSs 508-3 are not detected on the wireless carrier. According to some implementations, means for performing functionality at block 860 may comprise a bus 905, processors 910, DSP 920, wireless communication interface 930, memory 960, and/or other components of a UE, as illustrated in FIG. 9. According to some other implementations, means for performing functionality at block 810 may comprise a bus 1005, processors 1010, DSP 1020, wireless communication interface 1030, memory 1060, and/or other components of a base station, as illustrated in FIG. 10.

FIG. 9 is a block diagram of an embodiment of a UE 105, which can be utilized as described herein above (e.g., to implement one of RSUs 404-1, 404-2, 404-3, and 404-4 of FIGS. 4 and 5). For example, the UE 105 can perform one or more of the functions of the method shown in FIG. 8. It should be noted that FIG. 9 is meant only to provide a generalized illustration of various components, any or all of which may be utilized as appropriate. It can be noted that, in some instances, components illustrated by FIG. 9 can be localized to a single physical device and/or distributed among various networked devices, which may be disposed at different physical locations. Furthermore, as previously noted, the functionality of the UE discussed in the previously described embodiments may be executed by one or more of the hardware and/or software components illustrated in FIG. 9.

The UE 105 is shown comprising hardware elements that can be electrically coupled via a bus 905 (or may otherwise be in communication, as appropriate). The hardware elements may include a processor(s) 910 which can include without limitation one or more general-purpose processors (e.g., an application processor), one or more special-purpose processors (such as digital signal processor (DSP) chips, graphics acceleration processors, application specific integrated circuits (ASICs), and/or the like), and/or other processing structures or means. Processor(s) 910 may comprise one or more processing units, which may be housed in a single integrated circuit (IC) or multiple ICs. As shown in FIG. 9, some embodiments may have a separate DSP 920, depending on desired functionality. Location determination and/or other determinations based on wireless communication may be provided in the processor(s) 910 and/or wireless communication interface 930 (discussed below). The UE 105 also can include one or more input devices 970, which can include without limitation one or more keyboards, touch screens, touch pads, microphones, buttons, dials, switches, and/or the like; and one or more output devices 915, which can include without limitation one or more displays (e.g., touch screens), light emitting diodes (LEDs), speakers, and/or the like.

The UE 105 may also include a wireless communication interface 930, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the UE 105 to communicate with other devices as described in the embodiments above. The wireless communication interface 930 may permit data and signaling to be communicated (e.g., transmitted and received) with TRPs of a network, for example, via eNBs, gNBs, ng-eNBs, access points, various base stations and/or other access node types, and/or other network components, computer systems, and/or any other electronic devices communicatively coupled with TRPs, as described herein. The communication can be carried out via one or more wireless communication antenna(s) 932 that send and/or receive wireless signals 934. According to some embodiments, the wireless communication antenna(s) 932 may comprise a plurality of discrete antennas, antenna arrays, or any combination thereof. The antenna(s) 932 may be capable of transmitting and receiving wireless signals using beams (e.g., Tx beams and Rx beams). Beam formation may be performed using digital and/or analog beam formation techniques, with respective digital and/or analog circuitry. The wireless communication interface 930 may include such circuitry.

Depending on desired functionality, the wireless communication interface 930 may comprise a separate receiver and transmitter, or any combination of transceivers, transmitters, and/or receivers to communicate with base stations (e.g., ng-eNBs and gNBs) and other terrestrial transceivers, such as wireless devices and access points. The UE 105 may communicate with different data networks that may comprise various network types. For example, a WWAN may be a CDMA network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16) network, and so on. A CDMA network may implement one or more RATs such as CDMA2000®, WCDMA, and so on. CDMA2000® includes IS-95, IS-2000 and/or IS-856 standards. A TDMA network may implement GSM, Digital Advanced Mobile Phone System (D-AMPS), or some other RAT. An OFDMA network may employ LTE, LTE Advanced, 5G NR, and so on. 5G NR, LTE, LTE Advanced, GSM, and WCDMA are described in documents from 3GPP. CDMA2000® is described in documents from a consortium named “3rd Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The UE 105 can further include sensor(s) 940. Sensor(s) 940 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to obtain position-related measurements and/or other information.

Embodiments of the UE 105 may also include a Global Navigation Satellite System (GNSS) receiver 980 capable of receiving signals 984 from one or more GNSS satellites using an antenna 982 (which could be the same as antenna 932). Positioning based on GNSS signal measurement can be utilized to complement and/or incorporate the techniques described herein. The GNSS receiver 980 can extract a position of the UE 105, using conventional techniques, from GNSS satellites of a GNSS system, such as Global Positioning System (GPS), Galileo, GLONASS, Quasi-Zenith Satellite System (QZSS) over Japan, IRNSS over India, BeiDou Navigation Satellite System (BDS) over China, and/or the like. Moreover, the GNSS receiver 980 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 980 is illustrated in FIG. 9 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 910, DSP 920, and/or a processor within the wireless communication interface 930 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), particle filter, or the like. The positioning engine may also be executed by one or more processors, such as processor(s) 910 or DSP 920.

The UE 105 may further include and/or be in communication with a memory 960. The memory 960 can include, without limitation, local and/or network accessible storage, a disk drive, a drive array, an optical storage device, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 960 of the UE 105 also can comprise software elements (not shown in FIG. 9), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 960 that are executable by the UE 105 (and/or processor(s) 910 or DSP 920 within UE 105). In some embodiments, then, such code and/or instructions can be used to configure and/or adapt a general-purpose computer (or other device) to perform one or more operations in accordance with the described methods.

FIG. 10 is a block diagram of an embodiment of a base station 120, which can be utilized as described herein above (e.g., to implement one of RSUs 404-1, 404-2, 404-3, and 404-4 of FIGS. 4 and 5). For example, the UE 105 can perform one or more of the functions of the method shown in FIG. 8. It should be noted that FIG. 10 is meant only to provide a generalized illustration of various components, any or all of which may be utilized as appropriate. In some embodiments, the base station 120 may correspond to a gNB, an ng-eNB, and/or (more generally) a TRP.

The base station 120 is shown comprising hardware elements that can be electrically coupled via a bus 1005 (or may otherwise be in communication, as appropriate). The hardware elements may include a processor(s) 1010 which can include without limitation one or more general-purpose processors, one or more special-purpose processors (such as DSP chips, graphics acceleration processors, ASICs, and/or the like), and/or other processing structure or means. As shown in FIG. 10, some embodiments may have a separate DSP 1020, depending on desired functionality. Location determination and/or other determinations based on wireless communication may be provided in the processor(s) 1010 and/or wireless communication interface 1030 (discussed below), according to some embodiments. The base station 120 also can include one or more input devices, which can include without limitation a keyboard, display, mouse, microphone, button(s), dial(s), switch(es), and/or the like; and one or more output devices, which can include without limitation a display, light emitting diode (LED), speakers, and/or the like.

The base station 120 might also include a wireless communication interface 1030, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, cellular communication facilities, etc.), and/or the like, which may enable the base station 120 to communicate as described herein. The wireless communication interface 1030 may permit data and signaling to be communicated (e.g., transmitted and received) to UEs, other base stations/TRPs (e.g., eNBs, gNBs, and ng-eNBs), and/or other network components, computer systems, and/or any other electronic devices described herein. The communication can be carried out via one or more wireless communication antenna(s) 1032 that send and/or receive wireless signals 1034.

The base station 120 may also include a network interface 1080, which can include support of wireline communication technologies. The network interface 1080 may include a modem, network card, chipset, and/or the like. The network interface 1080 may include one or more input and/or output communication interfaces to permit data to be exchanged with a network, communication network servers, computer systems, and/or any other electronic devices described herein.

In many embodiments, the base station 120 may further comprise a memory 1060. The memory 1060 can include, without limitation, local and/or network accessible storage, a disk drive, a drive array, an optical storage device, a solid-state storage device, such as a RAM, and/or a ROM, which can be programmable, flash-updateable, and/or the like. Such storage devices may be configured to implement any appropriate data stores, including without limitation, various file systems, database structures, and/or the like.

The memory 1060 of the base station 120 also may comprise software elements (not shown in FIG. 10), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 1060 that are executable by the base station 120 (and/or processor(s) 1010 or DSP 1020 within base station 120). In some embodiments, then, such code and/or instructions can be used to configure and/or adapt a general-purpose computer (or other device) to perform one or more operations in accordance with the described methods.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:

Clause 1. A method for wireless communication by a wireless communication device, the method comprising detecting, on a wireless carrier, while a first synchronization reference is a synchronization reference source for the wireless communication device, a first reference signal associated with the first synchronization reference, transmitting sidelink synchronization signals (SLSSs) on the wireless carrier according to a timing indicated by the first reference signal, and responsive to a subsequent determination that the first synchronization reference has become unavailable, adopting a second synchronization reference as the synchronization reference source for the wireless communication device, initiating a wait interval, and following expiration of the wait interval, monitoring the wireless carrier for a second reference signal associated with the second synchronization reference and refraining from transmitting SLSSs on the wireless carrier while the second reference signal is not detected on the wireless carrier.

Clause 2. The method of clause 1, comprising, responsive to detecting the second reference signal on the wireless carrier while the second synchronization reference is the synchronization reference source for the wireless communication device, transmitting SLSSs on the wireless carrier according to a timing indicated by the second reference signal.

Clause 3. The method of any of clauses 1 to 2, wherein the second synchronization reference is a lower priority reference than the first synchronization reference.

Clause 4. The method of any of clauses 1 to 3, wherein the wireless communication device is a vehicle-to-everything (V2X) roadside unit (RSU).

Clause 5. The method of clause 4, wherein the V2X RSU is one of a plurality of V2X RSUs in a V2X RSU synchronization chain.

Clause 6. The method of clause 5, wherein the second synchronization reference corresponds to a second V2X RSU in the V2X RSU synchronization chain.

Clause 7. The method of any of clauses 1 to 6, wherein the first synchronization reference is a global navigation satellite system (GNSS) reference and the second synchronization reference is a synchronization reference (SyncRef) user equipment (UE).

Clause 8. The method of any of clauses 1 to 6, wherein the first synchronization reference is a first synchronization reference (SyncRef) user equipment (UE) and the second synchronization reference is a second SyncRef UE.

Clause 9. A wireless communication device, comprising a transceiver, a memory, and one or more processors communicatively coupled with the transceiver and the memory, wherein the one or more processors are configured to detect, on a wireless carrier, while a first synchronization reference is a synchronization reference source for the wireless communication device, a first reference signal associated with the first synchronization reference, transmit sidelink synchronization signals (SLSSs) on the wireless carrier according to a timing indicated by the first reference signal, and responsive to a subsequent determination that the first synchronization reference has become unavailable, adopt a second synchronization reference as the synchronization reference source for the wireless communication device, initiate a wait interval, and following expiration of the wait interval, monitor the wireless carrier for a second reference signal associated with the second synchronization reference and refrain from transmitting SLSSs on the wireless carrier while the second reference signal is not detected on the wireless carrier.

Clause 10. The wireless communication device of clause 9, wherein the one or more processors are configured to, responsive to detecting the second reference signal on the wireless carrier while the second synchronization reference is the synchronization reference source for the wireless communication device, transmit SLSSs on the wireless carrier according to a timing indicated by the second reference signal.

Clause 11. The wireless communication device of any of clauses 9 to 10, wherein the second synchronization reference is a lower priority reference than the first synchronization reference.

Clause 12. The wireless communication device of any of clauses 9 to 11, wherein the wireless communication device is a vehicle-to-everything (V2X) roadside unit (RSU).

Clause 13. The wireless communication device of clause 12, wherein the V2X RSU is one of a plurality of V2X RSUs in a V2X RSU synchronization chain.

Clause 14. The wireless communication device of clause 13, wherein the second synchronization reference corresponds to a second V2X RSU in the V2X RSU synchronization chain.

Clause 15. The wireless communication device of any of clauses 9 to 14, wherein the first synchronization reference is a global navigation satellite system (GNSS) reference and the second synchronization reference is a synchronization reference (SyncRef) user equipment (UE).

Clause 16. The wireless communication device of any of clauses 9 to 14, wherein the first synchronization reference is a first synchronization reference (SyncRef) user equipment (UE) and the second synchronization reference is a second SyncRef UE.

Clause 17. An apparatus for a wireless communication device, the apparatus comprising means for detecting, on a wireless carrier, while a first synchronization reference is a synchronization reference source for the wireless communication device, a first reference signal associated with the first synchronization reference, means for transmitting sidelink synchronization signals (SLSSs) on the wireless carrier according to a timing indicated by the first reference signal, and means for, responsive to a subsequent determination that the first synchronization reference has become unavailable, adopting a second synchronization reference as the synchronization reference source for the wireless communication device, initiating a wait interval, and following expiration of the wait interval, monitoring the wireless carrier for a second reference signal associated with the second synchronization reference and refraining from transmitting SLSSs on the wireless carrier while the second reference signal is not detected on the wireless carrier.

Clause 18. The apparatus of clause 17, comprising means for, responsive to detecting the second reference signal on the wireless carrier while the second synchronization reference is the synchronization reference source for the wireless communication device, transmitting SLSSs on the wireless carrier according to a timing indicated by the second reference signal.

Clause 19. The apparatus of any of clauses 17 to 18, wherein the second synchronization reference is a lower priority reference than the first synchronization reference.

Clause 20. The apparatus of any of clauses 17 to 19, wherein the apparatus is one of a plurality of vehicle-to-everything (V2X) roadside units (RSUs) in a V2X RSU synchronization chain, wherein the second synchronization reference corresponds to a second one of the plurality of V2X RSUs in the V2X RSU synchronization chain.

Clause 21. The apparatus of any of clauses 17 to 20, wherein the first synchronization reference is a global navigation satellite system (GNSS) reference and the second synchronization reference is a synchronization reference (SyncRef) user equipment (UE).

Clause 22. The apparatus of any of clauses 17 to 20, wherein the first synchronization reference is a first synchronization reference (SyncRef) user equipment (UE) and the second synchronization reference is a second SyncRef UE.

Clause 23. A non-transitory computer-readable medium storing instructions for wireless communication by a wireless communication device, the instructions comprising code for detecting, on a wireless carrier, while a first synchronization reference is a synchronization reference source for the wireless communication device, a first reference signal associated with the first synchronization reference, transmitting sidelink synchronization signals (SLSSs) on the wireless carrier according to a timing indicated by the first reference signal, and responsive to a subsequent determination that the first synchronization reference has become unavailable, adopting a second synchronization reference as the synchronization reference source for the wireless communication device, initiating a wait interval, and following expiration of the wait interval, monitoring the wireless carrier for a second reference signal associated with the second synchronization reference and refraining from transmitting SLSSs on the wireless carrier while the second reference signal is not detected on the wireless carrier.

Clause 24. The non-transitory computer-readable medium of clause 23, the instructions comprising code for, responsive to detecting the second reference signal on the wireless carrier while the second synchronization reference is the synchronization reference source for the wireless communication device, transmitting SLSSs on the wireless carrier according to a timing indicated by the second reference signal.

Clause 25. The non-transitory computer-readable medium of any of clauses 23 to 24, wherein the second synchronization reference is a lower priority reference than the first synchronization reference.

Clause 26. The non-transitory computer-readable medium of any of clauses 23 to 25, wherein the wireless communication device is a vehicle-to-everything (V2X) roadside unit (RSU).

Clause 27. The non-transitory computer-readable medium of clause 26, wherein the V2X RSU is one of a plurality of V2X RSUs in a V2X RSU synchronization chain.

Clause 28. The non-transitory computer-readable medium of clause 27, wherein the second synchronization reference corresponds to a second V2X RSU in the V2X RSU synchronization chain.

Clause 29. The non-transitory computer-readable medium of any of clauses 23 to 28, wherein the first synchronization reference is a global navigation satellite system (GNSS) reference and the second synchronization reference is a synchronization reference (SyncRef) user equipment (UE).

Clause 30. The non-transitory computer-readable medium of any of clauses 23 to 28, wherein the first synchronization reference is a first synchronization reference (SyncRef) user equipment (UE) and the second synchronization reference is a second SyncRef UE.

What is claimed is:

1. A method for wireless communication by a wireless communication device, the method comprising:
detecting, on a wireless carrier, while a first synchronization reference is a synchronization reference source for the wireless communication device, a first reference signal associated with the first synchronization reference;
transmitting sidelink synchronization signals (SLSSs) on the wireless carrier according to a timing indicated by the first reference signal; and
responsive to a subsequent determination that the first synchronization reference has become unavailable:
adopting a second synchronization reference as the synchronization reference source for the wireless communication device;
initiating a wait interval; and
following expiration of the wait interval:
monitoring the wireless carrier for a second reference signal associated with the second synchronization reference; and
refraining from transmitting SLSSs on the wireless carrier while the second reference signal is not detected on the wireless carrier.

2. The method of claim 1, comprising, responsive to detecting the second reference signal on the wireless carrier while the second synchronization reference is the synchronization reference source for the wireless communication device, transmitting SLSSs on the wireless carrier according to a timing indicated by the second reference signal.

3. The method of claim 1, wherein the second synchronization reference is a lower priority reference than the first synchronization reference.

4. The method of claim 1, wherein the wireless communication device is a vehicle-to-everything (V2X) roadside unit (RSU).

5. The method of claim 4, wherein the V2X RSU is one of a plurality of V2X RSUs in a V2X RSU synchronization chain.

6. The method of claim 5, wherein the second synchronization reference corresponds to a second V2X RSU in the V2X RSU synchronization chain.

7. The method of claim 1, wherein the first synchronization reference is a global navigation satellite system (GNSS) reference and the second synchronization reference is a synchronization reference (SyncRef) user equipment (UE).

8. The method of claim 1, wherein the first synchronization reference is a first synchronization reference (SyncRef) user equipment (UE) and the second synchronization reference is a second SyncRef UE.

9. A wireless communication device, comprising:
a transceiver;
a memory; and
one or more processors communicatively coupled with the transceiver and the memory, wherein the one or more processors are configured to:
detect, on a wireless carrier, while a first synchronization reference is a synchronization reference source for the wireless communication device, a first reference signal associated with the first synchronization reference;
transmit sidelink synchronization signals (SLSSs) on the wireless carrier according to a timing indicated by the first reference signal; and
responsive to a subsequent determination that the first synchronization reference has become unavailable:
adopt a second synchronization reference as the synchronization reference source for the wireless communication device;
initiate a wait interval; and
following expiration of the wait interval:
monitor the wireless carrier for a second reference signal associated with the second synchronization reference; and
refrain from transmitting SLSSs on the wireless carrier while the second reference signal is not detected on the wireless carrier.

10. The wireless communication device of claim 9, wherein the one or more processors are configured to, responsive to detecting the second reference signal on the wireless carrier while the second synchronization reference is the synchronization reference source for the wireless communication device, transmit SLSSs on the wireless carrier according to a timing indicated by the second reference signal.

11. The wireless communication device of claim 9, wherein the second synchronization reference is a lower priority reference than the first synchronization reference.

12. The wireless communication device of claim 9, wherein the wireless communication device is a vehicle-to-everything (V2X) roadside unit (RSU).

13. The wireless communication device of claim 12, wherein the V2X RSU is one of a plurality of V2X RSUs in a V2X RSU synchronization chain.

14. The wireless communication device of claim 13, wherein the second synchronization reference corresponds to a second V2X RSU in the V2X RSU synchronization chain.

15. The wireless communication device of claim 9, wherein the first synchronization reference is a global navigation satellite system (GNSS) reference and the second synchronization reference is a synchronization reference (SyncRef) user equipment (UE).

16. The wireless communication device of claim 9, wherein the first synchronization reference is a first synchronization reference (SyncRef) user equipment (UE) and the second synchronization reference is a second SyncRef UE.

17. An apparatus for a wireless communication device, the apparatus comprising:
means for detecting, on a wireless carrier, while a first synchronization reference is a synchronization reference source for the wireless communication device, a first reference signal associated with the first synchronization reference;
means for transmitting sidelink synchronization signals (SLSSs) on the wireless carrier according to a timing indicated by the first reference signal; and
means for, responsive to a subsequent determination that the first synchronization reference has become unavailable:
adopting a second synchronization reference as the synchronization reference source for the wireless communication device;
initiating a wait interval; and
following expiration of the wait interval:
monitoring the wireless carrier for a second reference signal associated with the second synchronization reference; and
refraining from transmitting SLSSs on the wireless carrier while the second reference signal is not detected on the wireless carrier.

18. The apparatus of claim 17, comprising means for, responsive to detecting the second reference signal on the wireless carrier while the second synchronization reference is the synchronization reference source for the wireless communication device, transmitting SLSSs on the wireless carrier according to a timing indicated by the second reference signal.

19. The apparatus of claim 17, wherein the second synchronization reference is a lower priority reference than the first synchronization reference.

20. The apparatus of claim 17, wherein the apparatus is one of a plurality of vehicle-to-everything (V2X) roadside units (RSUs) in a V2X RSU synchronization chain, wherein the second synchronization reference corresponds to a second one of the plurality of V2X RSUs in the V2X RSU synchronization chain.

21. The apparatus of claim 17, wherein the first synchronization reference is a global navigation satellite system (GNSS) reference and the second synchronization reference is a synchronization reference (SyncRef) user equipment (UE).

22. The apparatus of claim 17, wherein the first synchronization reference is a first synchronization reference (SyncRef) user equipment (UE) and the second synchronization reference is a second SyncRef UE.

23. A non-transitory computer-readable medium storing instructions for wireless communication by a wireless communication device, the instructions comprising code for:
detecting, on a wireless carrier, while a first synchronization reference is a synchronization reference source for the wireless communication device, a first reference signal associated with the first synchronization reference;
transmitting sidelink synchronization signals (SLSSs) on the wireless carrier according to a timing indicated by the first reference signal; and
responsive to a subsequent determination that the first synchronization reference has become unavailable:
adopting a second synchronization reference as the synchronization reference source for the wireless communication device;
initiating a wait interval; and
following expiration of the wait interval:
monitoring the wireless carrier for a second reference signal associated with the second synchronization reference; and
refraining from transmitting SLSSs on the wireless carrier while the second reference signal is not detected on the wireless carrier.

24. The non-transitory computer-readable medium of claim 23, the instructions comprising code for, responsive to detecting the second reference signal on the wireless carrier while the second synchronization reference is the synchronization reference source for the wireless communication device, transmitting SLSSs on the wireless carrier according to a timing indicated by the second reference signal.

25. The non-transitory computer-readable medium of claim 23, wherein the second synchronization reference is a lower priority reference than the first synchronization reference.

26. The non-transitory computer-readable medium of claim 23, wherein the wireless communication device is a vehicle-to-everything (V2X) roadside unit (RSU).

27. The non-transitory computer-readable medium of claim 26, wherein the V2X RSU is one of a plurality of V2X RSUs in a V2X RSU synchronization chain.

28. The non-transitory computer-readable medium of claim 27, wherein the second synchronization reference corresponds to a second V2X RSU in the V2X RSU synchronization chain.

29. The non-transitory computer-readable medium of claim 23, wherein the first synchronization reference is a global navigation satellite system (GNSS) reference and the second synchronization reference is a synchronization reference (SyncRef) user equipment (UE).

30. The non-transitory computer-readable medium of claim 23, wherein the first synchronization reference is a first synchronization reference (SyncRef) user equipment (UE) and the second synchronization reference is a second SyncRef UE.
